(19) United States
(12) Patent Application Publication
(10) Pub. No.: US 2020/0341487 A1
(43) Pub. Date: Oct. 29, 2020

(54) System and Method to Operate an Automated Vehicle

(71) Applicant: Aptiv Technologies Limited, St. Michael (BB)

(72) Inventors: Lawrence D. Hazelton, Goodrich, MI (US); Craig A. Baldwin, Pleasant Ridge, MI (US); Robert J. Myers, Saline, MI (US); James M. Chan, Washington Township, MI (US); Patrick M. Griffin, Lake Orion, MI (US)

(73) Assignee: Aptiv Technologies Limited, St. Michael (BB)

(21) Appl. No.: 16/927,859

(22) Filed: Jul. 13, 2020

Related U.S. Application Data
(62) Division of application No. 15/792,960, filed on Oct. 25, 2017.
Application No. 15/792,960 is a division of application No. 14/983,695, filed on Dec. 30, 2015, now abandoned.
(60) Provisional application No. 62/112,770, filed on Feb. 6, 2015.
(60) Provisional application No. 62/112,775, filed on Feb. 6, 2015.
(60) Provisional application No. 62/112,776, filed on Feb. 6, 2015.
(60) Provisional application No. 62/112,786, filed on Feb. 6, 2015.
(60) Provisional application No. 62/112,789, filed on Feb. 6, 2015.
(60) Provisional application No. 62/112,792, filed on Feb. 6, 2015.
(60) Provisional application No. 62/112,771, filed on Feb. 6, 2015.
(60) Provisional application No. 62/112,783, filed on Feb. 6, 2015.

(51) Int. Cl. G05D 1/02; B60W 30/00

(52) U.S. Cl. CPC G05D 1/0257; G05D 1/0246; G05D 2201/0213; G05D 1/0274; B60W 30/00

(57) ABSTRACT

Systems and methods for operating an automated vehicle such as an autonomous vehicle may include an autonomous guidance system, a method of automatically controlling and autonomous vehicle based on electronic messages from roadside infrastructure or other-vehicles, a method of automatically controlling an autonomous vehicle based on cellular telephone location information, pulsed LED vehicle-to-vehicle (V2V) communication system, a method and apparatus for controlling an autonomous vehicle, an autonomous vehicle with unobtrusive sensors, and adaptive cruise control integrated with a lane keeping assist system. The systems and methods may use information from radar, lidar, a camera or vision/image devices, ultrasonic sensors, and digital map data to determine a route or roadway position and provide for steering, braking, and acceleration control of a host vehicle.

### RELATED APPLICATIONS

This application is a divisional of, and claims priority to U.S. Utility patent application Ser. No. 15/792,960, filed Oct. 25, 2017, which is a divisional of U.S. Utility patent application Ser. No. 14/983,695, filed Dec. 30, 2015, which in turn claims the benefit under 35 U.S.C. § 119(e) of U.S. Provisional Patent Application Nos. 62/112,770, 62/112,776, 62/112,786, 62/112,792, 62/112,771, 62/112,775, 62/112,783, 62/112,789, all of which were filed Feb. 6, 2015, the entire disclosures of which is hereby incorporated herein by reference in their entireties.

### TECHNICAL FIELD OF INVENTION

This disclosure generally relates to systems and methods of operating automated vehicles.

### BACKGROUND

Partially and fully-automated or autonomous vehicles have been proposed. However, the systems and methods necessary to control the vehicle can be improved.

### SUMMARY

In accordance with one embodiment, an autonomous guidance system that operates a vehicle in an autonomous mode is provided. The system includes a camera module, a radar module, and a controller. The camera module outputs an image signal indicative of an image of an object in an area about a vehicle. The radar module outputs a reflection signal indicative of a reflected signal reflected by the object. The controller determines an object-location of the object on a map of the area based on a vehicle-location of the vehicle on the map, the image signal, and the reflection signal. The controller classifies the object as small when a magnitude of the reflection signal associated with the object is less than a signal-threshold.

In accordance with one embodiment, an autonomous guidance system that operates a vehicle in an autonomous mode is provided. The system includes a camera module, a radar module, and a controller. The camera module outputs an image signal indicative of an image of an object in an area about a vehicle. The radar module outputs a reflection signal indicative of a reflected signal reflected by the object. The controller generates a map of the area based on a vehicle-location of the vehicle, the image signal, and the reflection signal, wherein the controller classifies the object as small when a magnitude of the reflection signal associated with the object is less than a signal-threshold.

In accordance with an embodiment of the invention, a method off operating a autonomous vehicle is provided. The method includes the step of receiving a message from roadside infrastructure via an electronic receiver and the step of providing, by a computer system in communication with the electronic receiver, instructions based on the message to automatically implement countermeasure behavior by a vehicle system.

According to a first example, the roadside infrastructure is a traffic signaling device and data contained in the message includes a device location, a signal phase, and a phase timing. The vehicle system is a braking system. The step of providing instructions includes the sub-steps of:
determining a vehicle speed,
determining the signal phase in a current vehicle path, determining a distance between the vehicle and the device location, and
providing, by the computer system, instructions to the braking system to apply vehicle brakes based on the vehicle speed, the signal phase of the current vehicle path, and the distance between the vehicle and the device location.

According to a second example, the roadside infrastructure is a construction zone warning device and data contained in the message includes the information of a zone location, a zone direction, a zone length, a zone speed limit, and/or lane closures. The vehicle system may be a braking system, a steering system, and/or a powertrain system. The step of providing instructions may include the sub-steps of:
determining a vehicle speed,
determining a lateral vehicle location within a roadway,
determining a distance between the vehicle and the zone location,
determining a difference between the vehicle speed and the zone speed limit,
providing, by the computer system, instructions to apply vehicle brakes based on the difference between the vehicle speed and the zone speed limit and the distance between the vehicle and the zone location,
determining a steering angle based on the lateral vehicle location, the lane closures, the vehicle speed, and the distance between the vehicle and the zone location,
providing, by the computer system, instructions to the steering system to adjust a vehicle path based on the steering angle, and
providing, by the computer system, instructions to the powertrain system to adjust the vehicle speed so the vehicle speed is less than or equal to the zone speed limit.

According to a third example, the roadside infrastructure is a stop sign and data contained in the message includes sign location and stop direction. The vehicle system is a braking system. The step of providing instructions may include the sub-steps:
determining vehicle speed,
determining the stop direction of a current vehicle path,
determining a distance between the vehicle and the sign location, and
providing, by the computer system, instructions to the braking system to apply vehicle brakes based on a vehicle speed, the stop direction of the current vehicle path, and the distance between the vehicle and the sign location.

According to a fourth example, the roadside infrastructure is a railroad crossing warning device and data contained in the message includes device location and warning state. The vehicle system is a braking system. The step of providing instructions includes the sub-steps of:
determining vehicle speed,
determining the warning state,
determining a distance between the vehicle and the device location, and
providing, by the computer system, instructions to the braking system to apply vehicle brakes based on the vehicle speed, warning state, and the distance between the vehicle and the device location.

According to a fifth example, the roadside infrastructure is an animal crossing zone warning device and data contained in the message includes zone location, zone direction, and zone length. The vehicle system is a forward looking sensor. The step of providing instructions includes the sub-step of providing, by the computer system, instructions to the forward looking sensor to widen a field of view so as to include at least both road shoulders within the field of view.

According to a sixth example, the roadside infrastructure is a pedestrian crossing warning device and data contained in the message may be crossing location and/or warning state. The vehicle system may be a braking system and/or a forward looking sensor. The step of providing instructions may include the sub-steps of:
providing, by the computer system, instructions to the forward looking sensor to widen a field of view so as to include at least both road shoulders within the field of view,
determining vehicle speed,
determining a distance between the vehicle and the crossing location, and
providing, by the computer system, instructions to the braking system to apply vehicle brakes based on the vehicle speed, warning state, and the distance between the vehicle and the crossing location.

According to a seventh example, the roadside infrastructure is a school crossing warning device and data contained in the message a device location and a warning state. The vehicle system is a braking system. The step of providing instructions includes the sub-steps of:
determining vehicle speed,
determining a lateral location of the device location within a roadway,
determining a distance between the vehicle and the device location, and
providing, by the computer system, instructions to the braking system to apply vehicle brakes based on a vehicle speed, the lateral location, the warning state, and the distance between the vehicle and the device location.

According to an eighth example, the roadside infrastructure is a lane direction indicating device and data contained in the message is a lane location and a lane direction. The vehicle system is a roadway mapping system. The step of providing instructions includes the sub-step of providing, by the computer system, instructions to the roadway mapping system to dynamically update the roadway mapping system's lane direction information.

According to a ninth example, the roadside infrastructure is a speed limiting device and data contained in the message includes a speed zone location, a speed zone direction, a speed zone length, and a zone speed limit. The vehicle system is a powertrain system. The step of providing instructions includes the sub-steps of:
determining a vehicle speed,
determining a distance between the vehicle and the speed zone location, and
providing, by the computer system, instructions to the powertrain system to adjust the vehicle speed so that the vehicle speed is less than or equal to the zone speed limit.

According to a tenth example, the roadside infrastructure is a no passing zone device and data contained in the message includes a no passing zone location, a no passing zone direction, and a no passing zone length. The vehicle system includes a powertrain system, a forward looking sensor and/or a braking system. The step of providing instructions may include the sub-steps of:
detecting another vehicle ahead of the vehicle via the forward looking sensor,
determining a vehicle speed,
determining an another vehicle speed.
determine a safe passing distance for overtaking the another vehicle,
determining a distance between the vehicle and the no passing zone location,
providing, by the computer system, instructions to the powertrain system to adjust the vehicle speed so that the vehicle speed is less than or equal to the another vehicle speed when the safe passing distance would end within the no passing zone, and
providing, by the computer system, instructions to the braking system to adjust the vehicle speed so that the vehicle speed is less than or equal to the another vehicle speed when the safe passing distance would end within the no passing zone.

In accordance with another embodiment, another method of operating an autonomous vehicle is provided. The method comprises the step of receiving a message from another vehicle via an electronic receiver, and the step of providing, by a computer system in communication with said electronic receiver, instructions based on the message to automatically implement countermeasure behavior by a vehicle system.

According to a first example, the other vehicle is a school bus and data contained in the message includes school bus location and stop signal status. The vehicle system is a braking system. The step of providing instructions includes the sub-steps of:
determining a vehicle speed,
determining the stop signal status,
determining a distance between the vehicle and the school bus location, and
providing, by the computer system, instructions to the braking system to apply vehicle brakes based on the vehicle speed, the stop signal status, and the distance between the vehicle and the school bus location.

According to a second example, the other vehicle is a maintenance vehicle and data contained in the message includes a maintenance vehicle location and a safe following distance. The vehicle system is a powertrain system and/or a braking system. The step of providing instructions may include the sub-steps of:
determining a distance between the vehicle and the maintenance vehicle location,
determining a difference between the safe following distance and the distance between the vehicle and the maintenance vehicle location by subtracting the distance between the vehicle and the maintenance vehicle location from the safe following distance,
providing, by the computer system, instructions to the braking system to apply vehicle brakes when the difference is less than zero, and
providing, by the computer system, instructions to the powertrain system to adjust a vehicle speed so that the difference is less than or equal to zero.

According to a third example, the other vehicle is an emergency vehicle and data contained in the message may include information regarding an emergency vehicle location, an emergency vehicle speed, and a warning light status. The vehicle system is a braking system, a steering system, a forward looking sensor, and/or a powertrain system. The step of providing instructions may include the sub-steps:
determining a distance between the vehicle and the emergency vehicle,
determine a location of an unobstructed portion of a road shoulder via the forward looking sensor based on the distance between the vehicle and the emergency vehicle, the emergency vehicle speed, and warning light status,
providing, by the computer system, instructions to apply vehicle brakes based on the distance between the vehicle and the emergency vehicle, the emergency vehicle speed, and the location of the unobstructed portion of the road shoulder,
determining a steering angle based on the distance between the vehicle and the emergency vehicle, the emergency vehicle speed, and the location of the unobstructed portion of the road shoulder,
providing, by the computer system, instructions to the steering system to adjust a vehicle path based on the steering angle, and
providing, by the computer system, instructions to the powertrain system to adjust a vehicle speed based on the distance between the vehicle and the emergency vehicle, the emergency vehicle speed, and the location of the unobstructed portion of the road shoulder.

In accordance with an embodiment of the invention, a method of automatically operating a vehicle is provided. The method includes the steps of:
receiving a message indicating the location of a cellular telephone proximate to the vehicle,
determining a velocity of the cellular telephone based on changes in location over a period of time, and
providing, by a computer system in communication with said electronic receiver, instructions based on the location and velocity of the cellular telephone to automatically implement countermeasure behavior by a vehicle system.

In the case wherein the vehicle system is a braking system, the method may further include the steps of:
determining a vehicle velocity;
comparing the vehicle velocity with the cellular telephone velocity,
determining whether the concurrence between the vehicle location and the cellular telephone location will occur, and
providing, by the computer system, instructions to the braking system to apply vehicle brakes to avoid the concurrence if it is determined that the concurrence between the vehicle location and the cellular telephone location will occur.

In the case wherein the vehicle system is a steering system, the method may include the steps of:
determining a vehicle velocity,
comparing the vehicle velocity with the cellular telephone velocity,
determining whether the concurrence between the vehicle location and the cellular telephone location will occur,
determining a steering angle to avoid the concurrence if it is determined that the concurrence between the vehicle location and the cellular telephone location will occur, and
providing, by the computer system, instructions to the steering system to adjust a vehicle path based on the steering angle.

In the case wherein the vehicle system is a powertrain system, the method may further include the steps of:
determining a vehicle velocity,
comparing the vehicle velocity with the cellular telephone velocity,
determining whether the concurrence between the vehicle location and the cellular telephone location will occur, and
providing, by the computer system, instructions to the powertrain system to adjust the vehicle velocity to avoid the concurrence if it is determined that the concurrence between the vehicle location and the cellular telephone location will occur.

In the case wherein the vehicle system is a powertrain system and the cellular telephone is carried by another vehicle, the method may include the steps of:
determining a vehicle velocity,
comparing the vehicle velocity with the cellular telephone velocity,
determining whether the vehicle velocity and the cellular telephone velocity are substantially parallel and in a same direction,
determining whether a concurrence between the vehicle location and the cellular telephone location will occur, and
providing, by the computer system, instructions to the powertrain system to adjust the vehicle velocity maintain a following distance if it is determined that the vehicle velocity and the cellular telephone velocity are substantially parallel and in the same direction.

The cellular telephone may by carried by a pedestrian or may be carried by another vehicle.

The present disclosure provides a LED V2V Communication System for an on road vehicle. The LED V2V Communication System includes LED arrays for transmitting encoded data; optical receivers for receiving encoded data; a central-processing-unit (CPU) for processing and managing data flow between the LED arrays and optical receivers; and a control bus routing communication between the CPU and the vehicle's systems such as a satellite-based positioning system, driver infotainment system, and safety systems. The safety systems may include audio or visual driver alerts, active braking, seat belt pre-tensioners, air bags, and the likes.

The present disclosure also provides a method using pulse LED for vehicle-to-vehicle communication. The method includes the steps of receiving input information from an occupant or vehicle system of a transmitting vehicle; generating an output information based on the input information of the transmit vehicle; generating a digital signal based output information of the transmit vehicle; and transmitting the digital signal in the form of luminous digital pulses to a receiving vehicle. The receiving vehicle then receives the digital signal in the form of luminous digital pulses; generates a received message based on received digital signal; generate an action signal based on received information; and relay the action signal to the occupant or vehicle system of the received vehicle. The step of transmitting the digital signal to a receive vehicle includes generating luminous digital pulses in the infra-red or ultra-violet frequency invisible to the human eye.

One aspect of the disclosure involves a method comprising controlling by one or more computing devices an autonomous vehicle in accordance with a first control strategy; developing by one or more computing devices said first control strategy based at least in part on data contained on a first map; receiving by one or more computing devices sensor data from said vehicle corresponding to a first set of data contained on said first map; comparing said sensor data to said first set of data on said first map on a periodic basis; developing a first correlation rate between said sensor data and said first set of data on said first map; and adopting a second control strategy when said correlation rate drops below a predetermined value.

Another aspect of the disclosure involves a method comprising controlling by one or more computing devices an autonomous vehicle in accordance with a first control strategy; receiving by one or more computing devices map data corresponding to a route of said vehicle; developing by one or more computing devices a lane selection strategy; receiving by one or more computing devices sensor data from said vehicle corresponding to objects in the vicinity of said vehicle; and changing said lane selection strategy based on changes to at least one of said sensor data and said map data.

Another aspect of the disclosure involves a method comprising controlling by one or more computing devices an autonomous vehicle in accordance with a first control strategy; receiving by one or more computing devices sensor data from said vehicle corresponding to moving objects in the vicinity of said vehicle; receiving by one or more computing devices road condition data; determining by one or more computing devices undesirable locations for said vehicle relative to said moving objects; and wherein said step of determining undesirable locations for said vehicle is based at least in part on said road condition data.

Another aspect of the disclosure involves a method comprising controlling by one or more computing devices an autonomous vehicle in accordance with a first control strategy; developing by one or more computing devices said first control strategy based at least in part on data contained on a first map, wherein said first map is simultaneously accessible by more than one vehicle; receiving by one or more computing devices sensor data from said vehicle corresponding to objects in the vicinity of said vehicle; and updating by said one or more computing devices said first map to include information about at least one of said objects.

Another aspect of the disclosure involves a method comprising controlling by one or more computing devices an autonomous vehicle; activating a visible signal on said autonomous vehicle when said vehicle is being controlled by said one or more computing devices; and keeping said visible signal activated during the entire time that said vehicle is being controlled by said one or more computing devices.

Another aspect of the disclosure involves a method comprising controlling by one or more computing devices an autonomous vehicle in accordance with a first control strategy; receiving by one or more computing devices sensor data corresponding to a first location; detecting a first moving object at said first location; changing said first control strategy based on said sensor data relating to said first moving object; and wherein said sensor data is obtained from a first sensor that is not a component of said autonomous vehicle.

Another aspect of the disclosure involves a method comprising controlling by one or more computing devices an autonomous vehicle in accordance with a first control strategy; approaching an intersection with said vehicle; receiving by one or more computing devices sensor data from said autonomous vehicle corresponding to objects in the vicinity of said vehicle; determining whether another vehicle is at said intersection based on said sensor data; determining by said one or more computing devices whether said other vehicle or said autonomous vehicle has priority to proceed through said intersection; and activating a yield signal to indicate to said other vehicle that said autonomous vehicle is yielding said intersection.

The present disclosure also provides an autonomously driven car in which the sensors used to provide the 360 degrees of sensing do not extend beyond the pre-existing, conventional outer surface or skin of the vehicle.

The present disclosure provides an integrated active cruise control and lane keeping assist system. The potential exists for a car attempting to pass a leading car to fail in that pass attempt and be returned to the lane in which the leading car travels but too close to the leading car, or at least closer than the predetermined threshold that an active cruise control system would normally maintain.

In the preferred embodiment disclosed, the active cruise control system includes an additional and alternative deceleration scheme. If the vehicle fails in an attempt to pass a leading-vehicle, and makes a lane reentry behind the leading-vehicle that puts it at a following-distance less than the predetermined threshold normally maintained by the cruise control system, a more aggressive deceleration of the vehicle is imposed, as by braking or harder and longer braking, to return the vehicle quickly to the predetermined threshold-distance.

In another preferred embodiment a method of operating an adaptive cruise control system for use in a vehicle configured to actively maintain a following-distance behind a leading-vehicle at no less than a predetermined threshold-distance is provided. The method includes determining when a following-distance of a trailing-vehicle behind a leading-vehicle is less than a threshold-distance. The method also includes maintaining the following-distance when the following-distance is not less than the threshold-distance. The method also includes determining when the following-distance is less than a minimum-threshold that is less than the threshold-distance. The method also includes decelerating the trailing-vehicle at a normal-deceleration-rate when the following-distance is less than the threshold-distance and not less than the minimum-distance. The method also includes decelerating the trailing-vehicle at an aggressive-deceleration-rate when the following-distance is less than the minimum-distance.

Further features and advantages will appear more clearly on a reading of the following detailed description of the preferred embodiment, which is given by way of non-limiting example only and with reference to the accompanying drawings.

### BRIEF DESCRIPTION OF THE DRAWINGS

The present invention will now be described, by way of example with reference to the accompanying drawings, in which:

FIG. 1A is a top view of a vehicle equipped with an autonomous guidance system that includes a sensor assembly, according to one embodiment;

FIG. 2A is a block diagram of the assembly of FIG. 1A, according to one embodiment;

FIG. 3A is a perspective view of the assembly of FIG. 1A, according to one embodiment; and

FIG. 4A is a side view of the assembly of FIG. 1A, according to one embodiment.

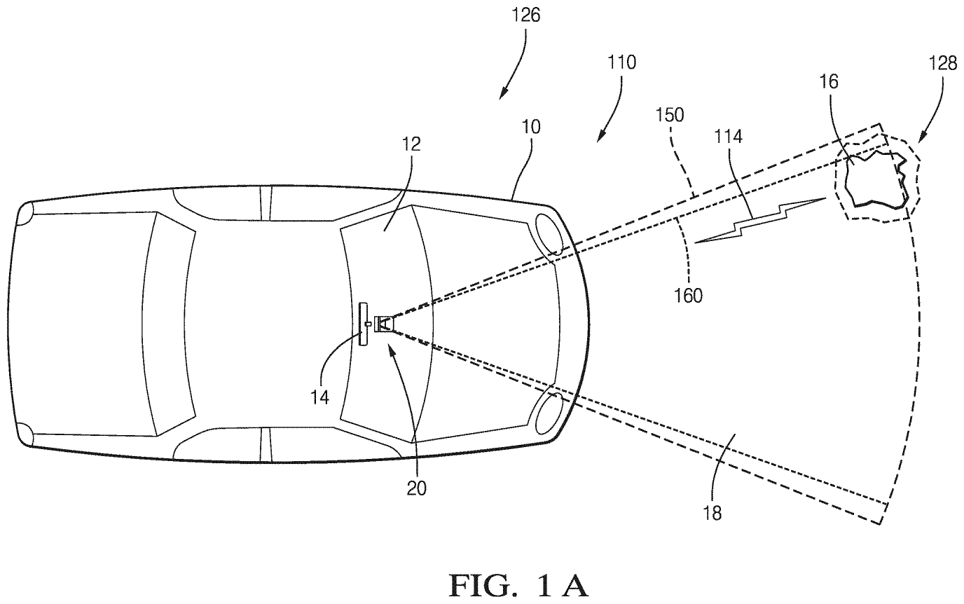

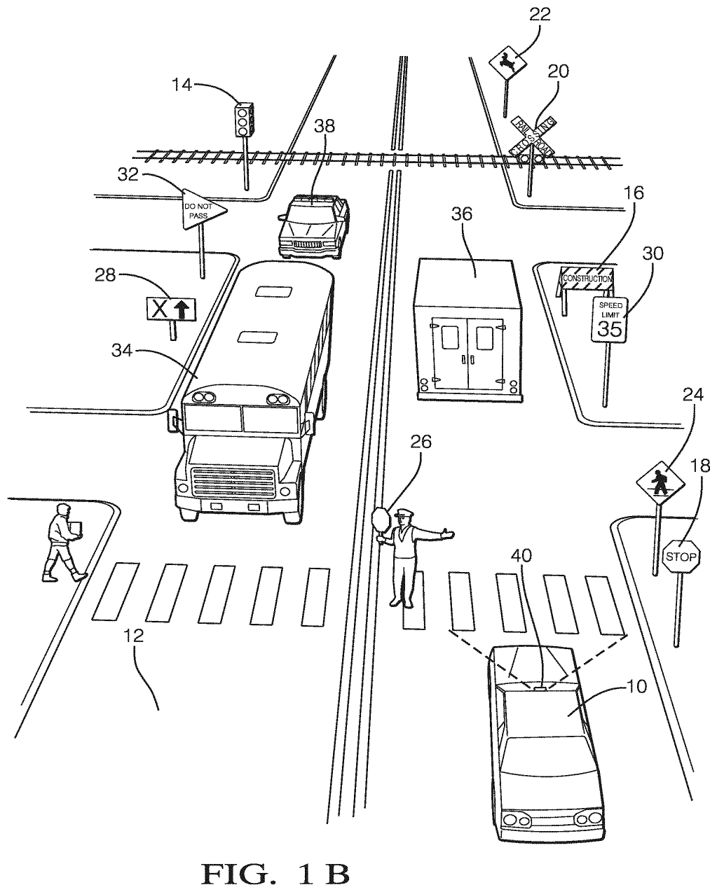

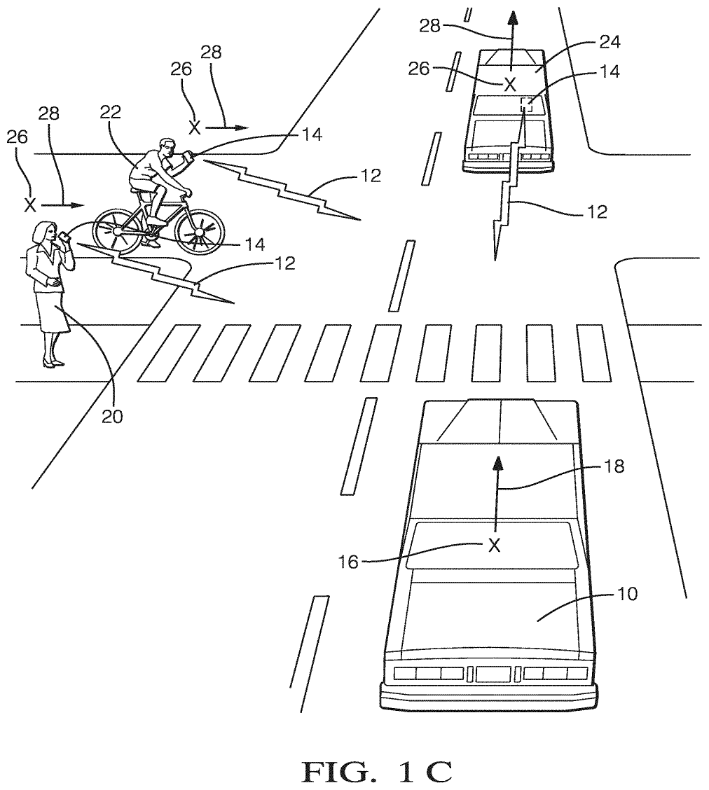

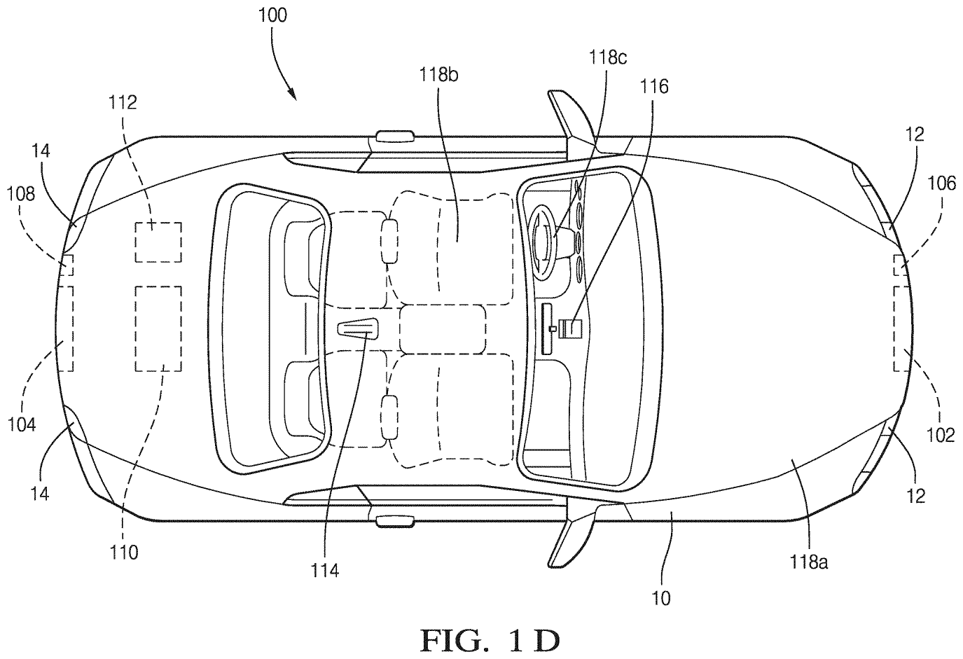

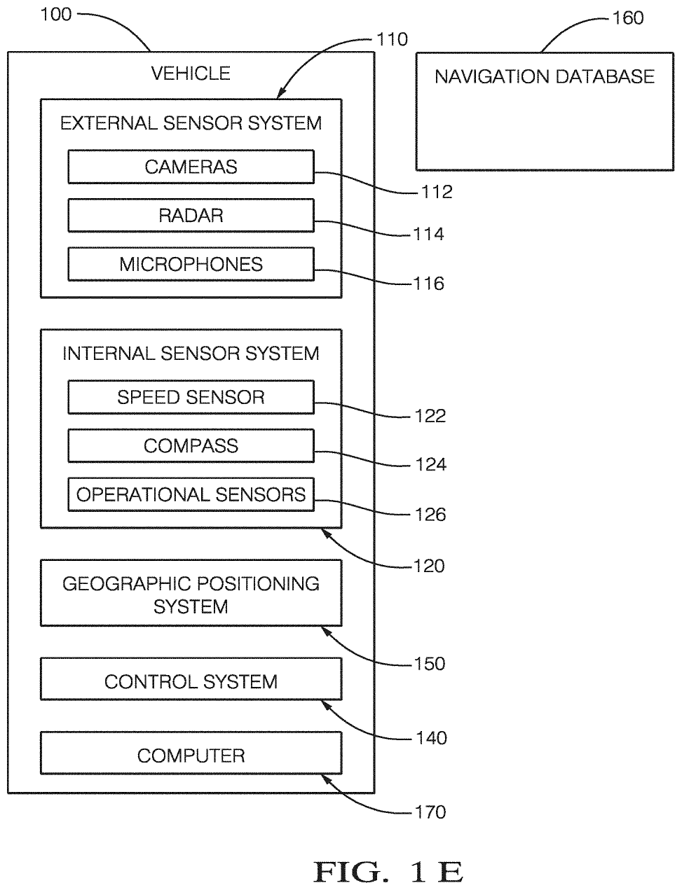

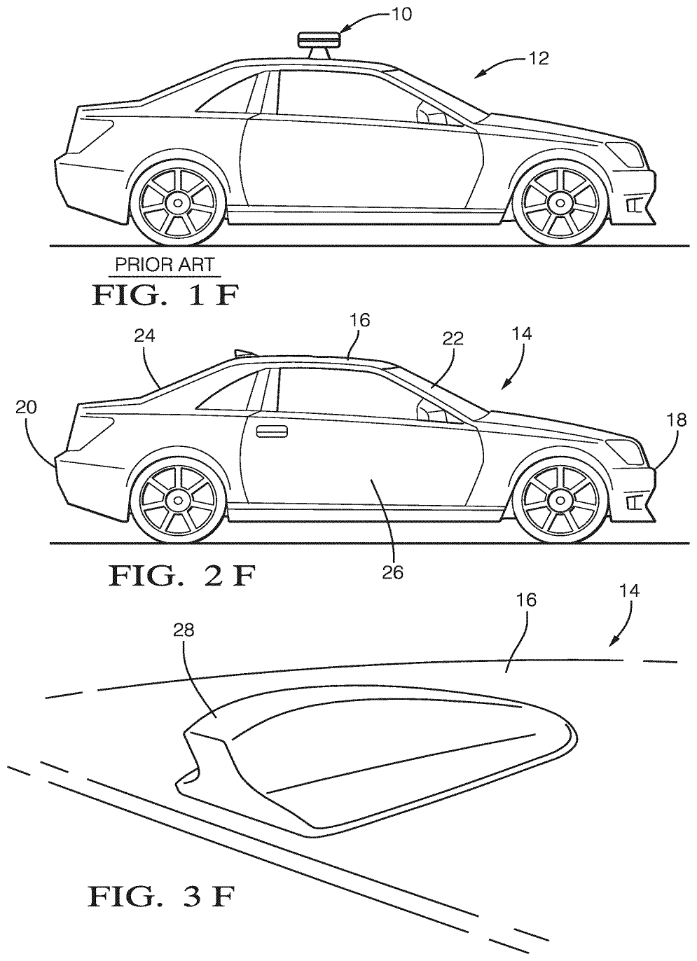

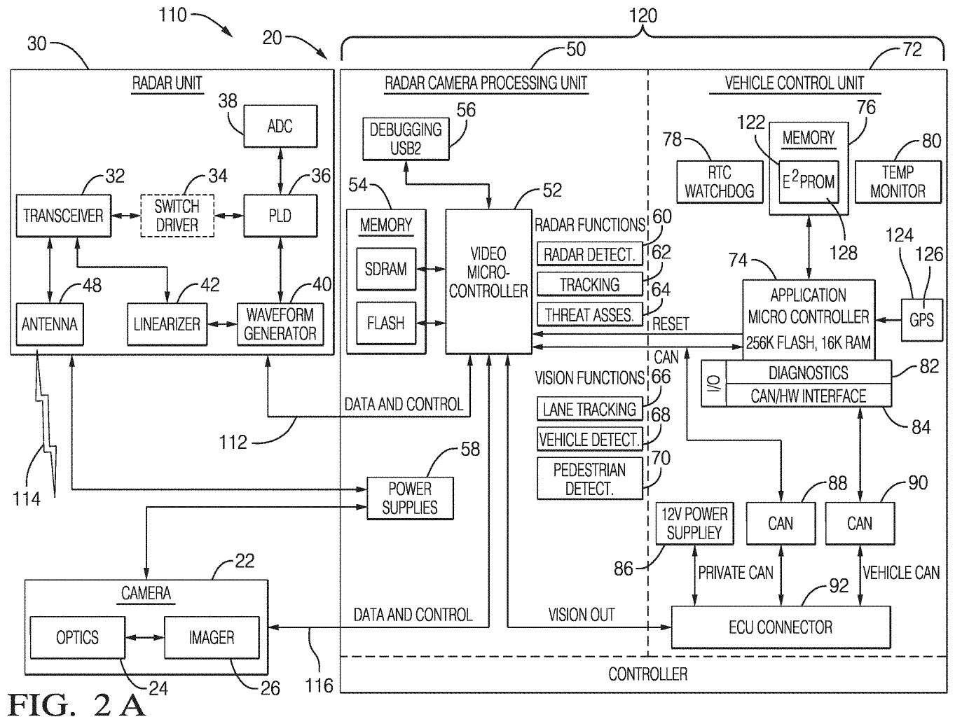

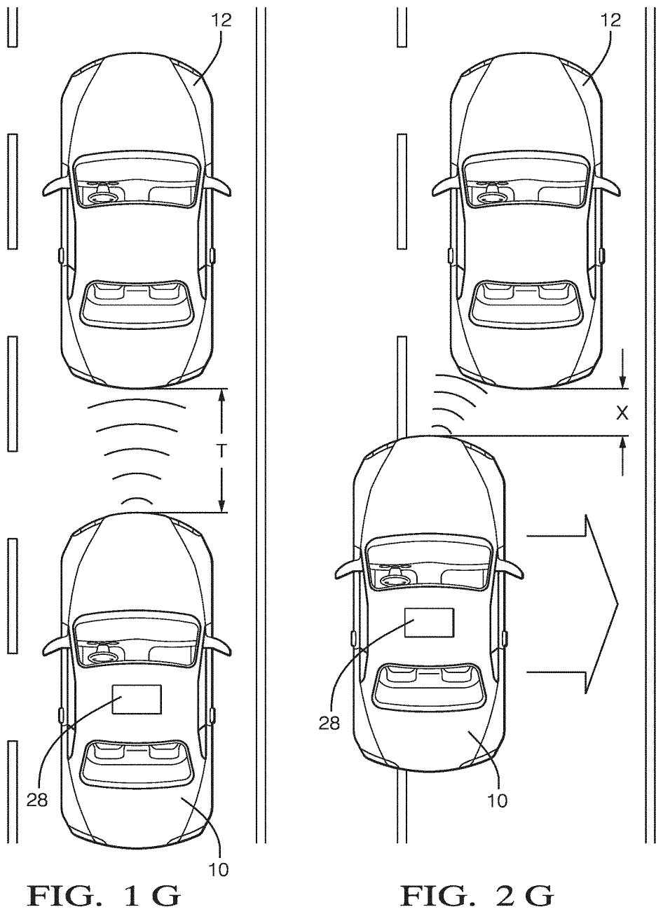

FIG. 1B is a diagram of an operating environment for an autonomous vehicle;

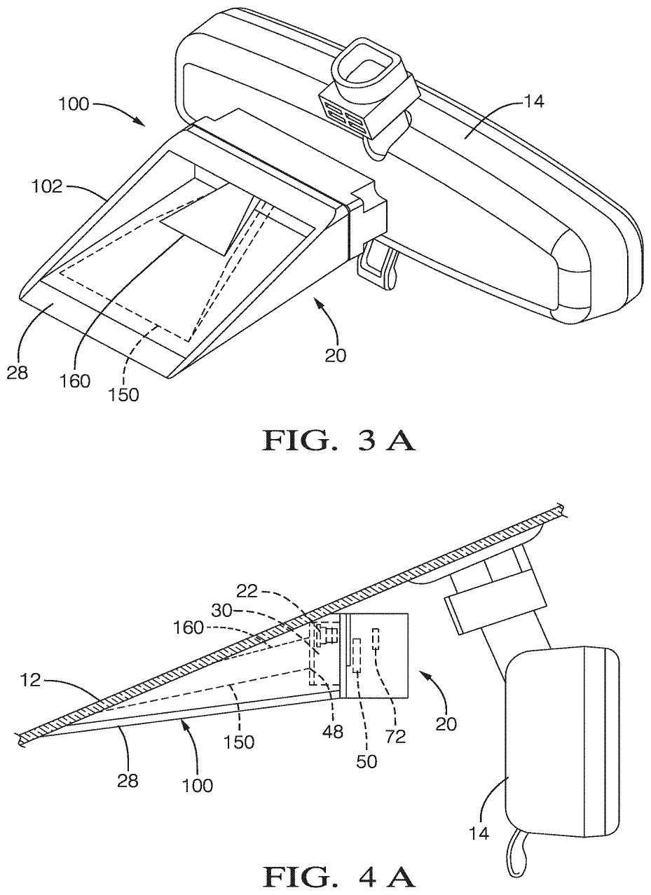

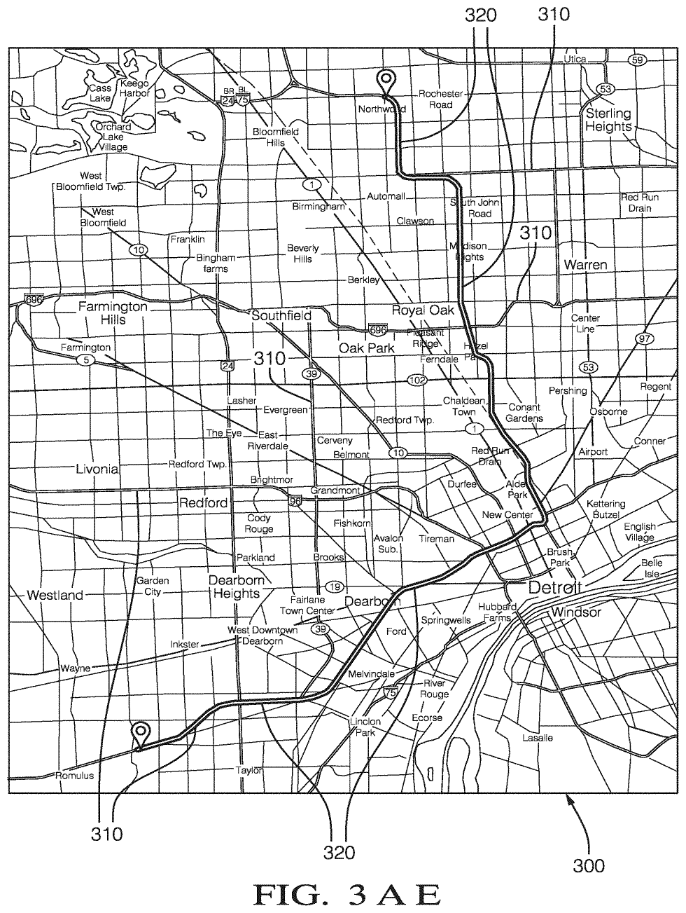

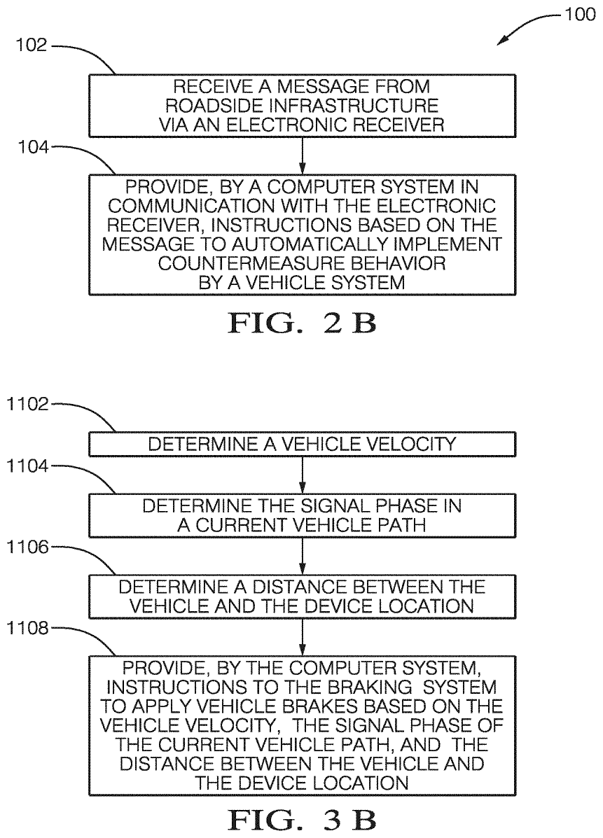

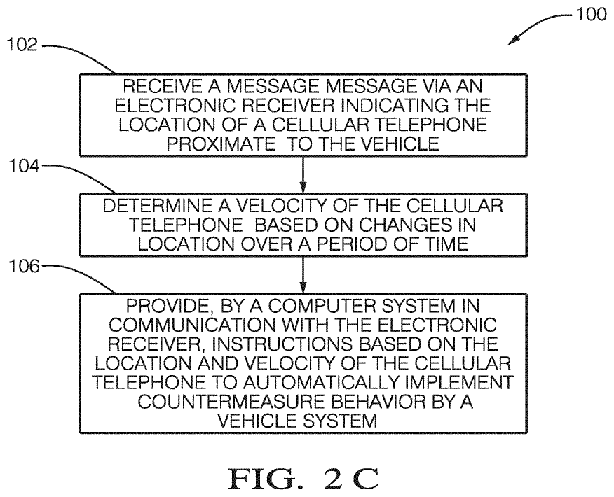

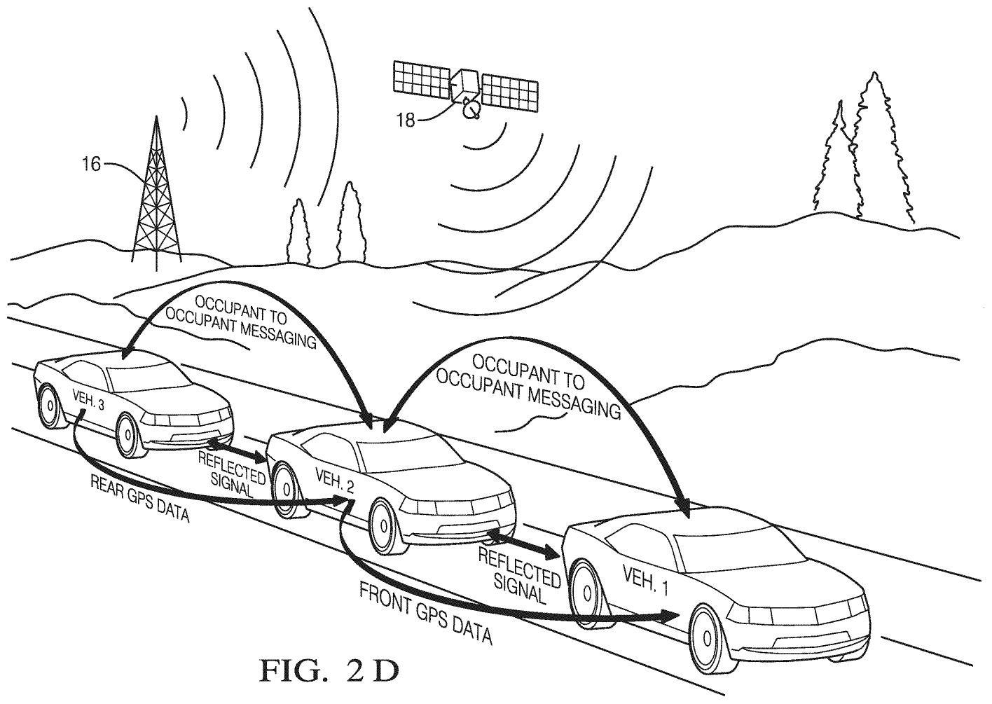

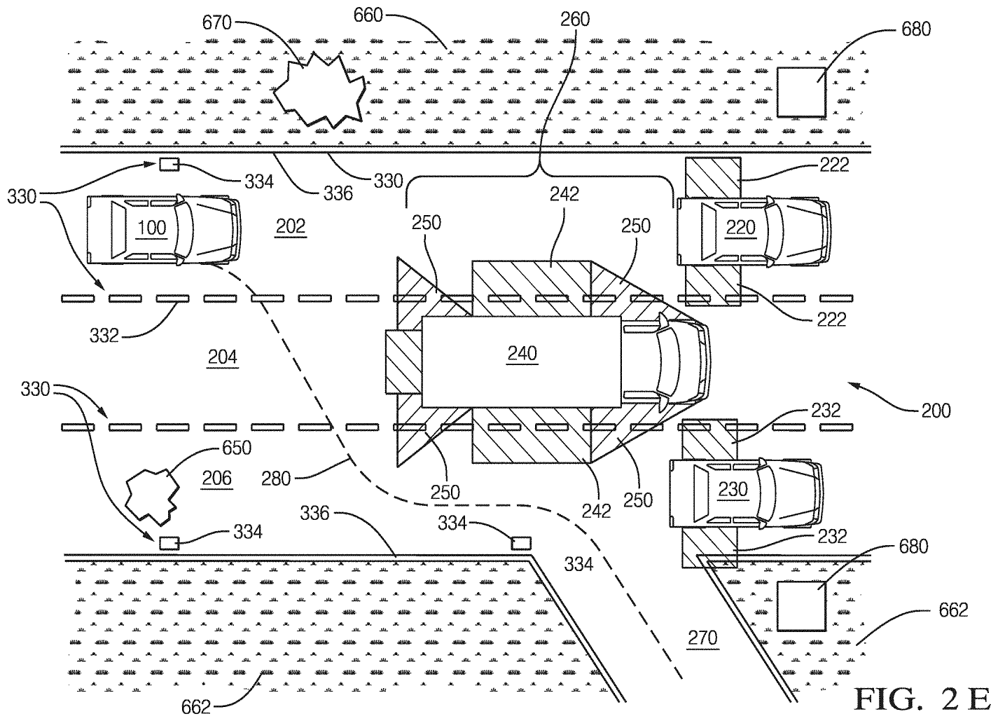

FIG. 2B is flowchart of a method of operating an autonomous vehicle according to a first embodiment;

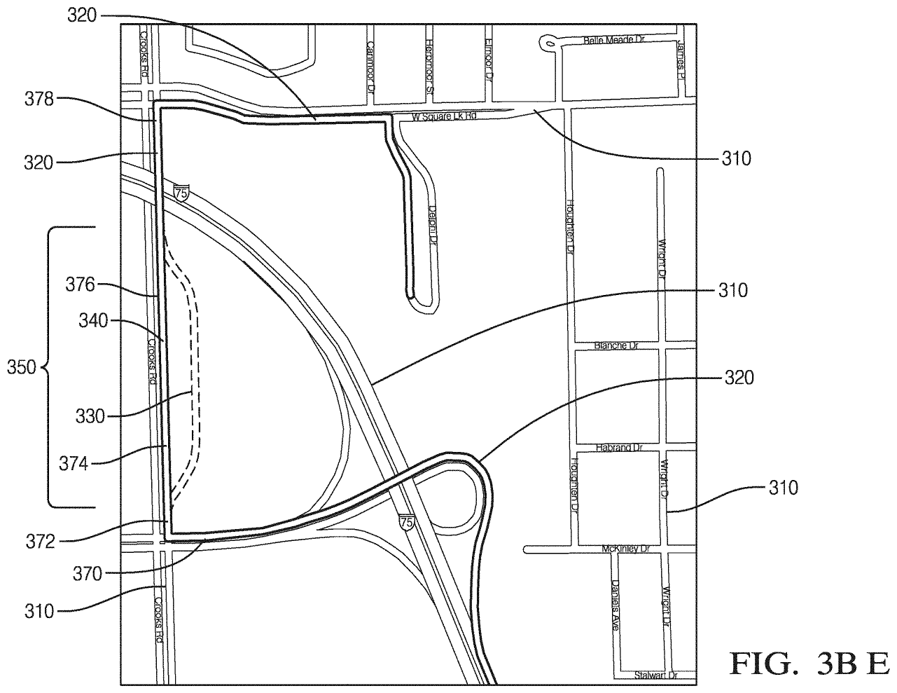

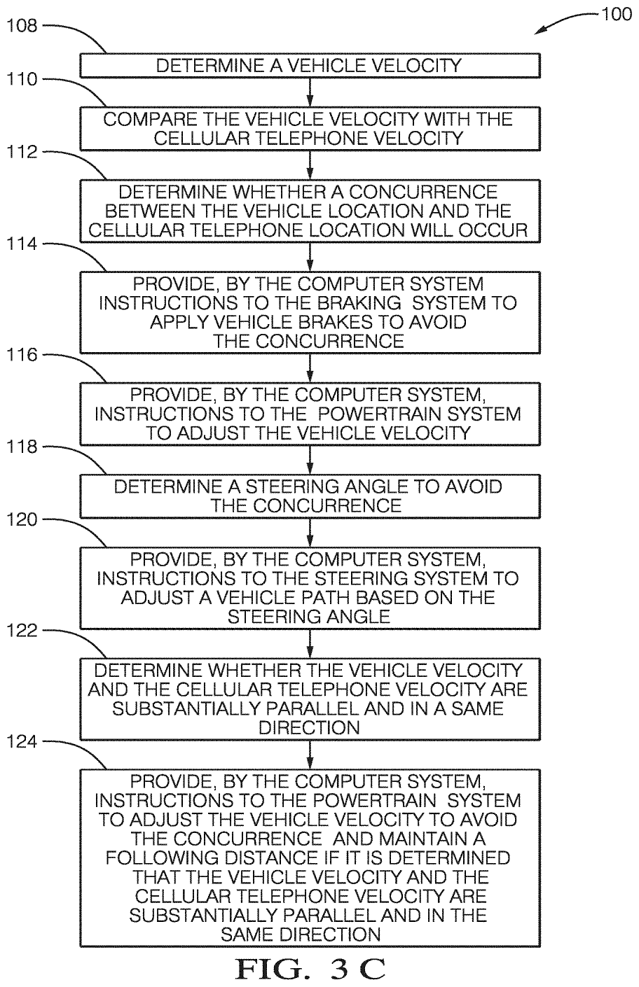

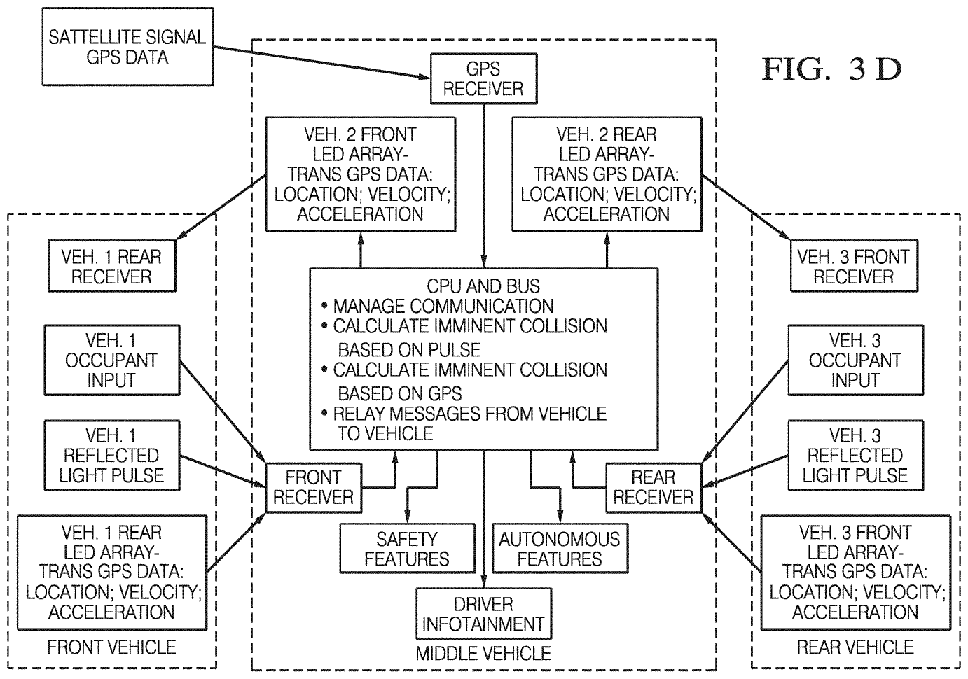

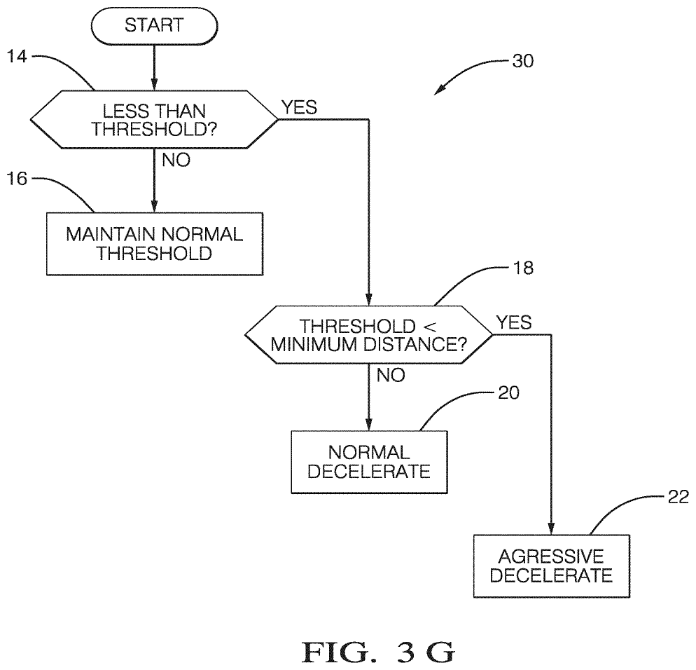

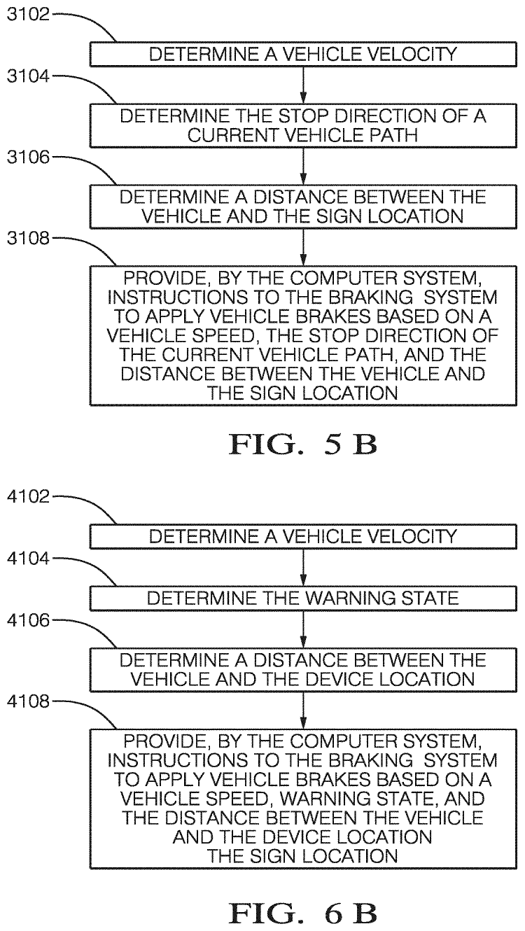

FIG. 3B is flowchart of a first set of sub-steps of STEP 104B of the method illustrated in FIG. 2B;

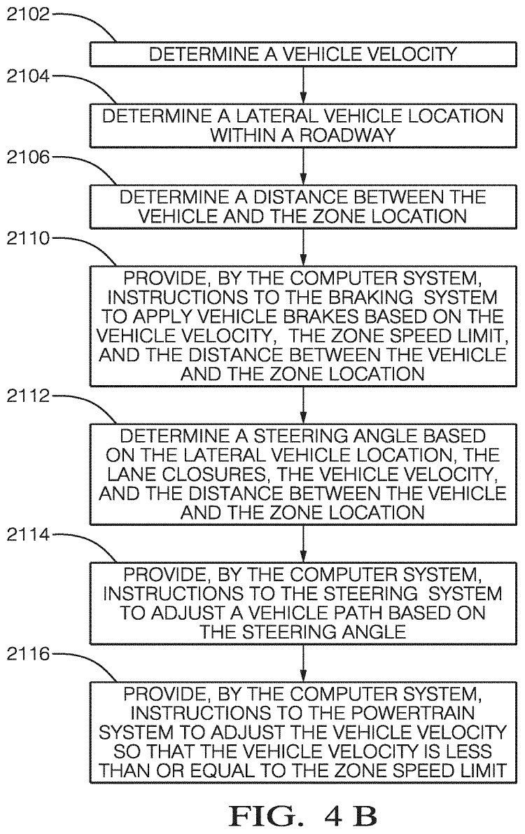

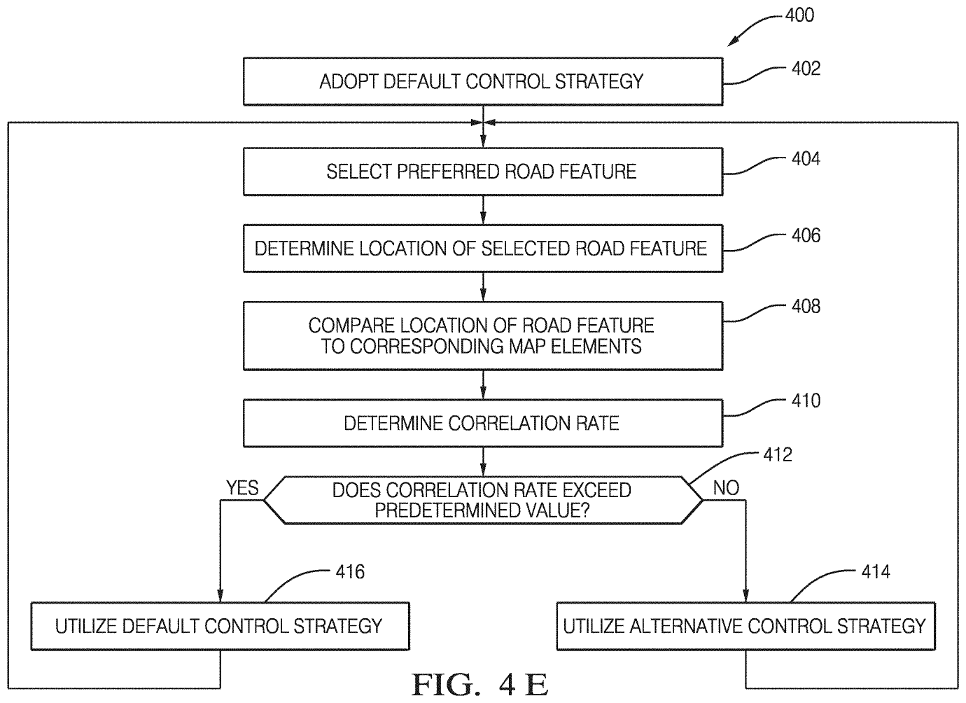

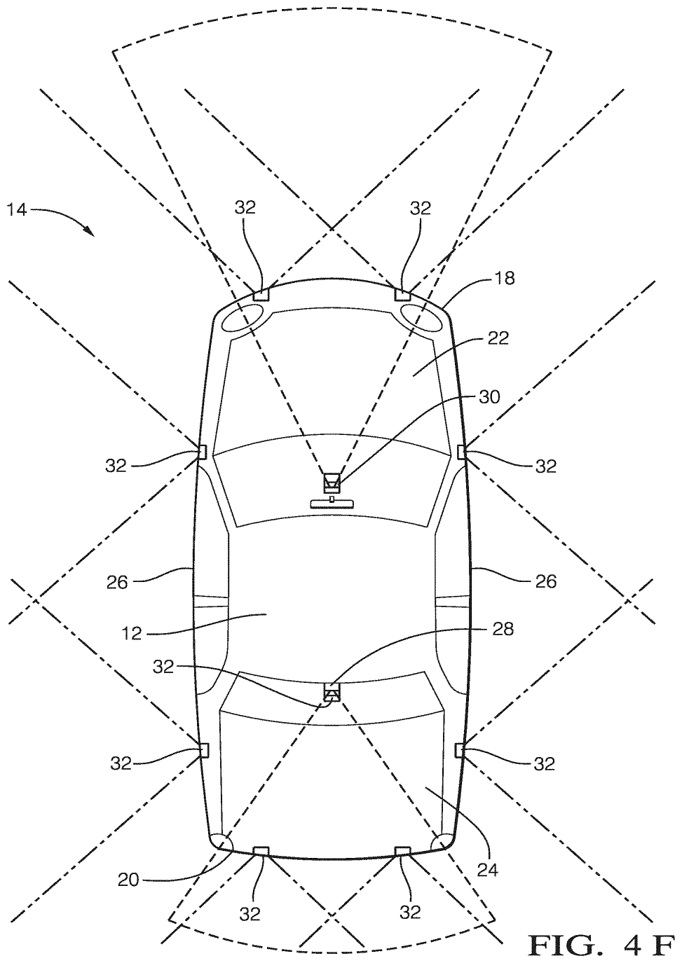

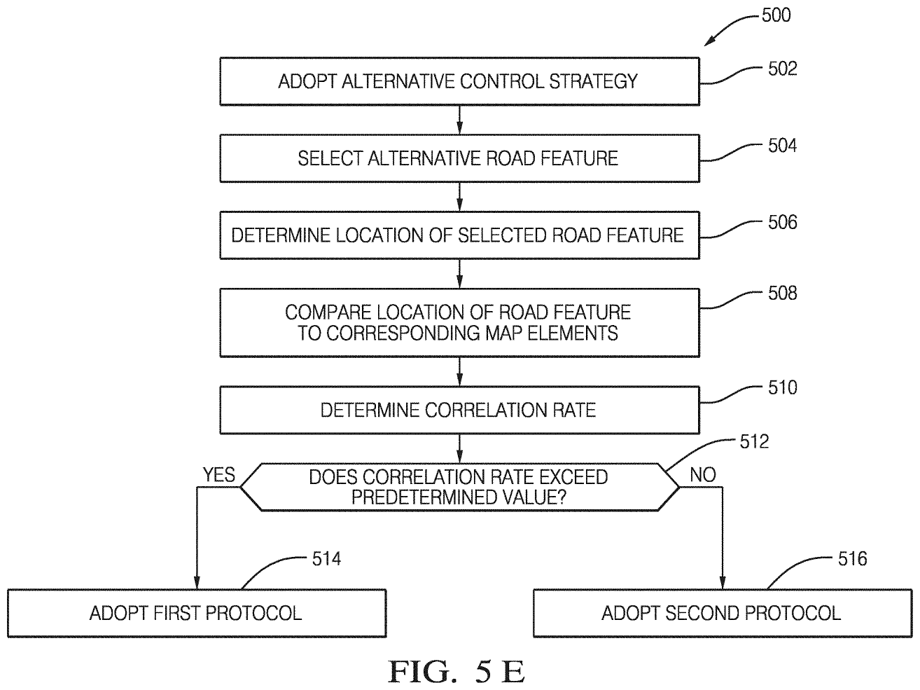

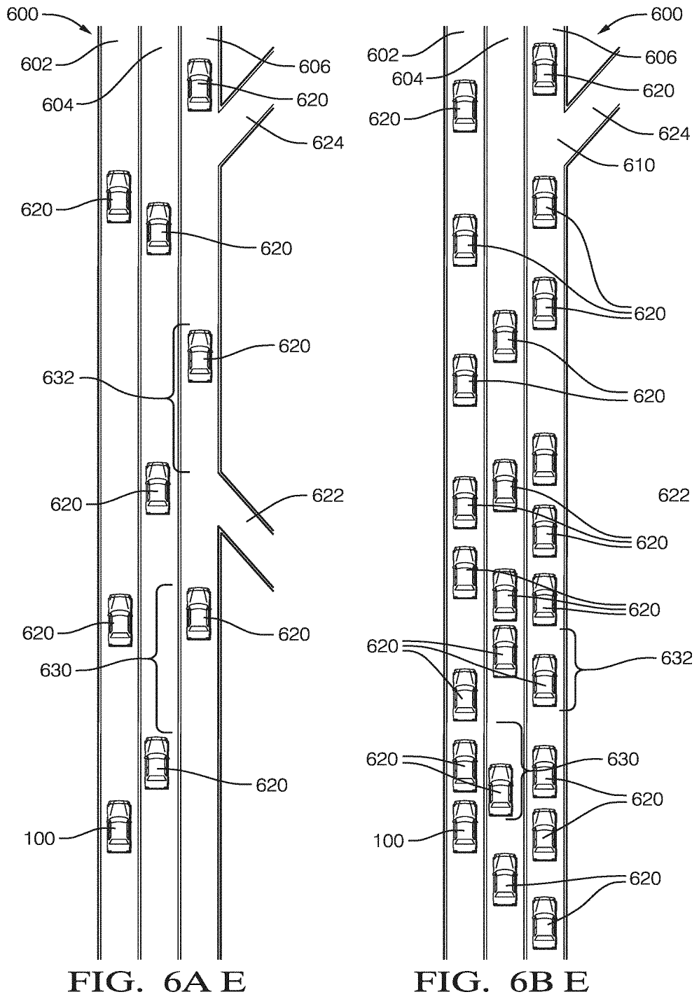

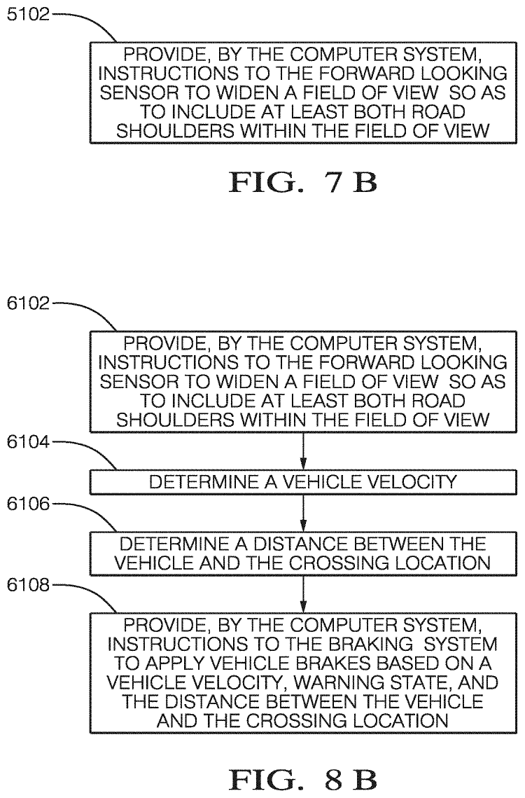

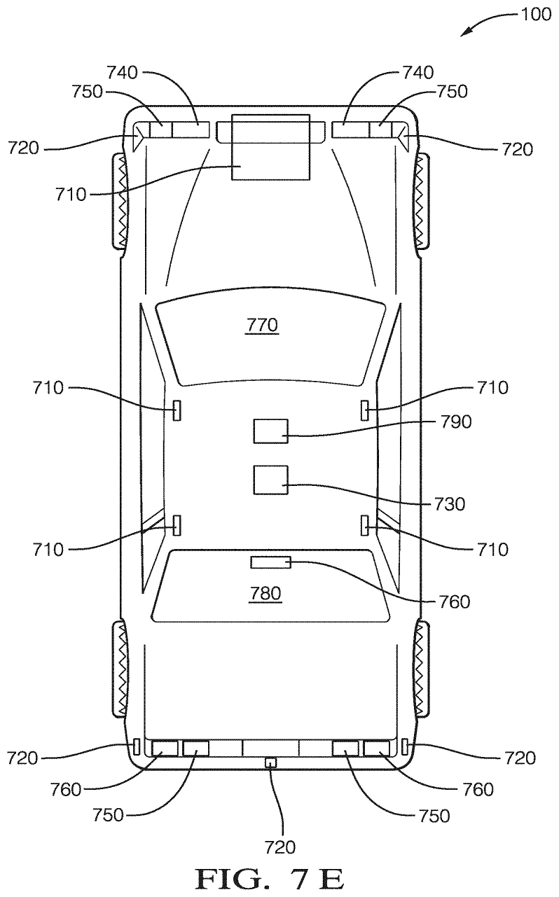

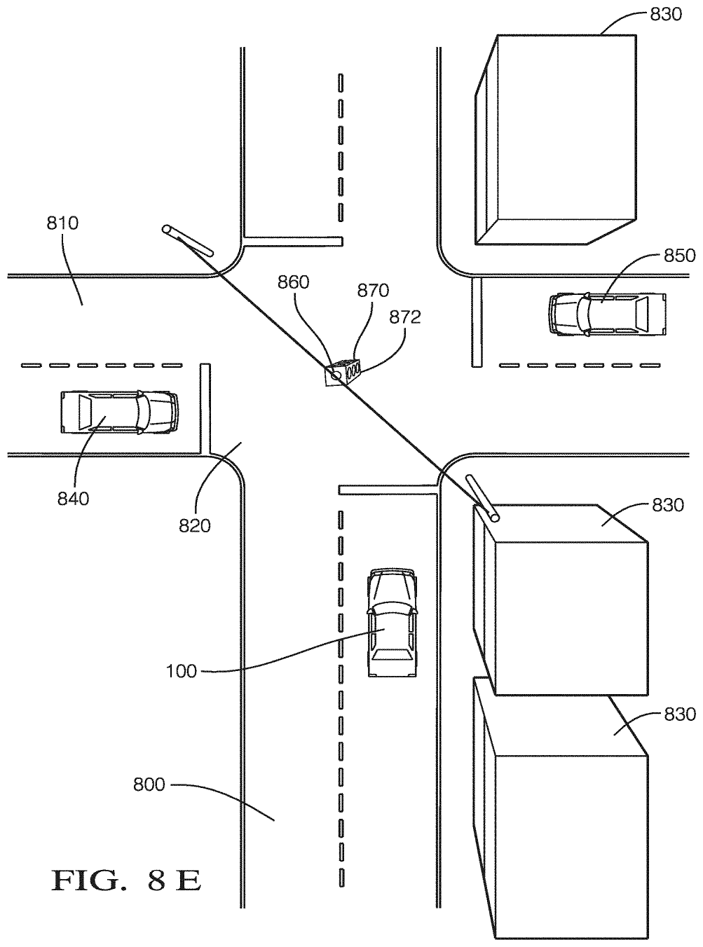

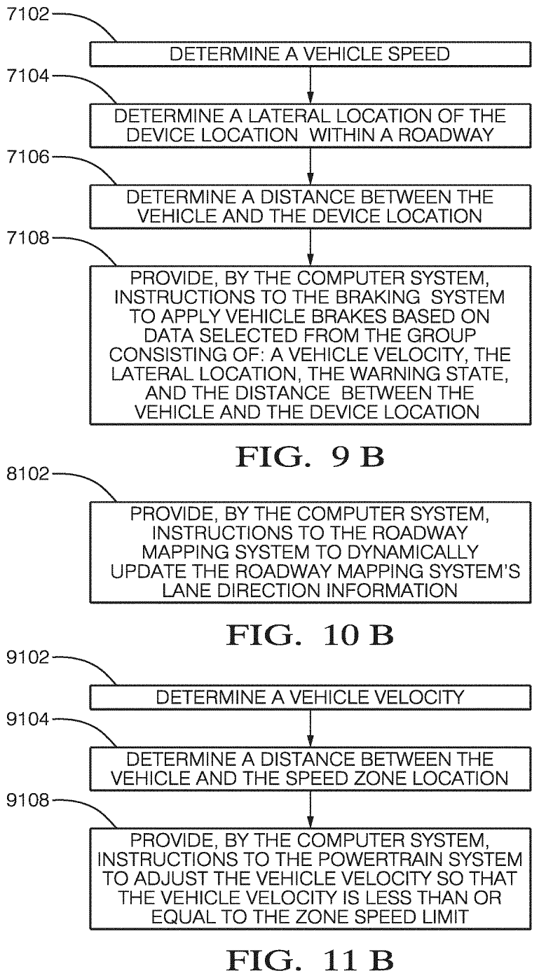

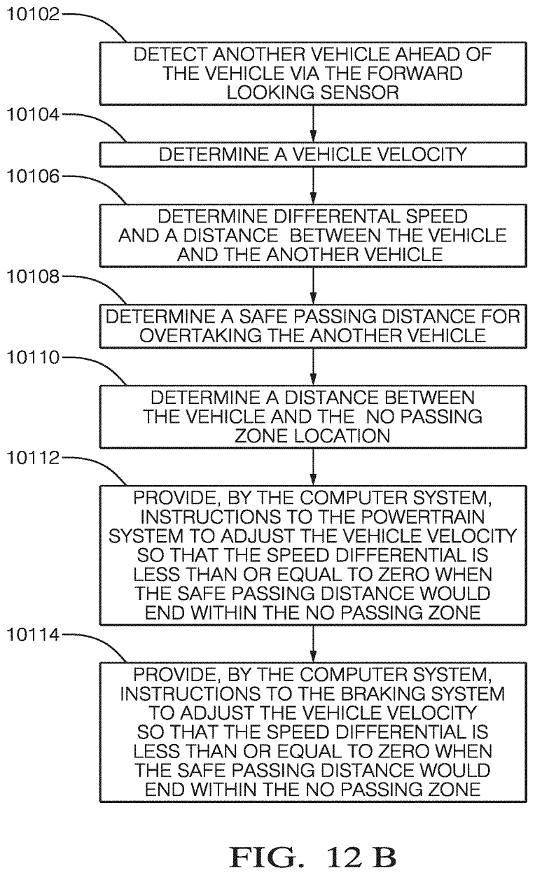

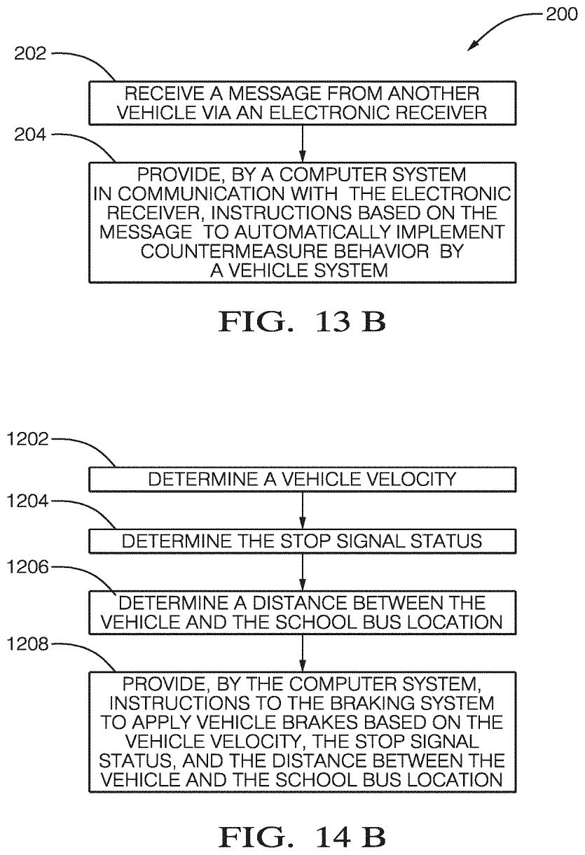

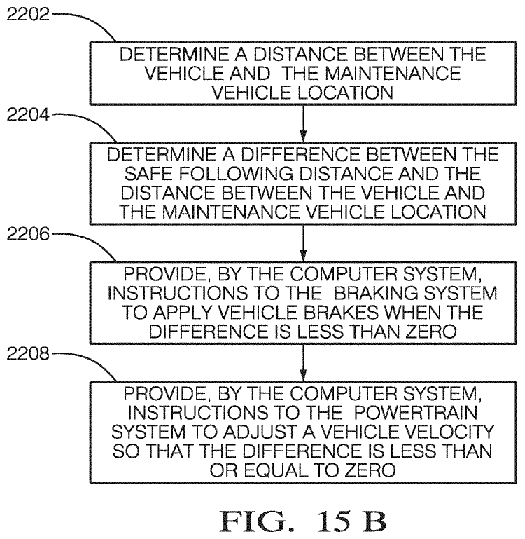

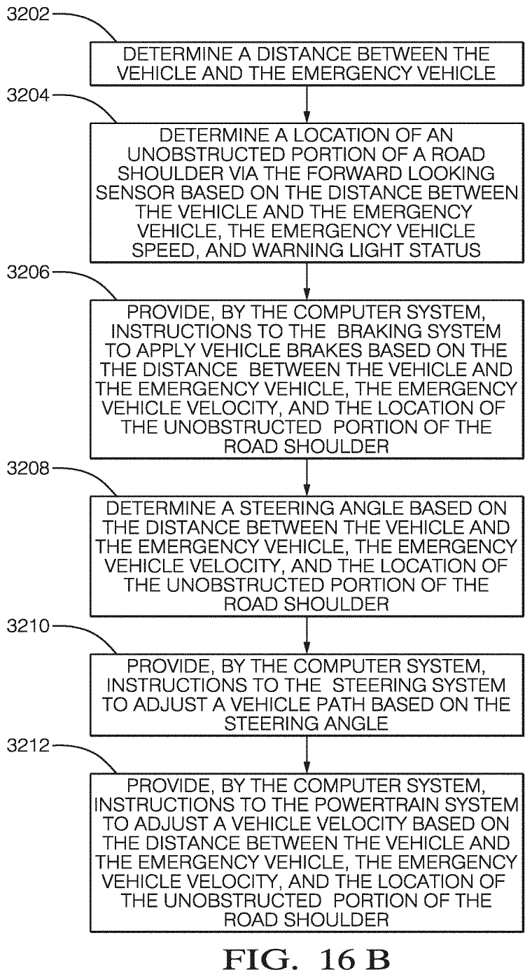

FIG. 4B is flowchart of a second set of sub-steps of STEP 104B of the method illustrated in FIG. 2B;

FIG. 5B is flowchart of a third set of sub-steps of STEP 104B of the method illustrated in FIG. 2B;

FIG. 6B is flowchart of a fourth set of sub-steps of STEP 104B of the method illustrated in FIG. 2B;

FIG. 7B is flowchart of a fifth set of sub-steps of STEP 104B of the method illustrated in FIG. 2B;

FIG. 8B is flowchart of a sixth set of sub-steps of STEP 104B of the method illustrated in FIG. 2B;

FIG. 9B is flowchart of a seventh set of sub-steps of STEP 104B of the method illustrated in FIG. 2B;

FIG. 10B is flowchart of an eighth set of sub-steps of STEP 104B of the method illustrated in FIG. 2B;

FIG. 11B is flowchart of a ninth set of sub-steps of STEP 104B of the method illustrated in FIG. 2B;

FIG. 12B is flowchart of a tenth set of sub-steps of STEP 104B of the method illustrated in FIG. 2B;

FIG. 13B is flowchart of a method of operating an autonomous vehicle according to a second embodiment;

FIG. 14B is flowchart of a first set of sub-steps of STEP 204B of the method illustrated in FIG. 13B;

FIG. 15B is flowchart of a second set of sub-steps of STEP 204B of the method illustrated in FIG. 13B; and

FIG. 16B is flowchart of a third set of sub-steps of STEP 204B of the method illustrated in FIG. 13B.

FIG. 1C is a diagram of an operating environment for a vehicle according to one embodiment;

FIG. 2C is flowchart of a method of operating a vehicle according to one embodiment; and

FIG. 3C is flowchart of optional steps in the method of FIG. 2C according to one embodiment.

FIG. 1D is schematic representation showing an on road vehicle having an exemplary embodiment of the Light Emitting Diode Vehicle to Vehicle (LED V2V) Communication System of the current invention;

FIG. 2D is a schematic representation showing three vehicles traveling in a single file utilizing the LED V2V Communication System for inter vehicle communication; and

FIG. 3D is a block diagram showing information transfer from the front and rear vehicles to and from the center vehicle of FIG. 2D.

FIG. 1E is a functional block diagram illustrating an autonomous vehicle in accordance with an example embodiment;

FIG. 2E is a diagram of an autonomous vehicle travelling along a highway in accordance with aspects of the disclosure;

FIG. 3aE is a diagram illustrating map data received by an autonomous vehicle from an external database;

FIG. 3bE is an enlarged view of a portion of the map data illustrated in FIG. 3aE including map data sensed by the autonomous vehicle in accordance with aspects of the disclosure;

FIG. 4E is a flow chart of a first control method for an autonomous vehicle in accordance with aspects of the disclosure;

FIG. 5E is a flow chart of a second control method for an autonomous vehicle in accordance with aspects of the disclosure;

FIG. 6aE is diagram of an autonomous vehicle travelling along a highway with a first traffic density in accordance with aspects of the disclosure;

FIG. 6bE is diagram of an autonomous vehicle travelling along a highway with a second traffic density in accordance with aspects of the disclosure;

FIG. 7E is a top view of an autonomous vehicle in accordance with an example embodiment; and

FIG. 8E is a diagram of an autonomous vehicle travelling along a road that has buildings and obstructions adjacent to the road.

FIG. 1F is side view of a known-vehicle;

FIG. 2F is side view of a vehicle;

FIG. 3F is an enlarged view of the back roof line of the vehicle; and

FIG. 4F is a schematic top view of the vehicle showing the range of coverage of the various sensors.

FIG. 1G is a schematic view of a trailing-vehicle following a leading-vehicle at the predetermined or normal threshold-distance;

FIG. 2G is a view of the trailing-vehicle reentering its lane at and a distance from the leading-vehicle less than the predetermined threshold; and

FIG. 3G is a flow chart of the method comprising the subject invention.

### DETAILED DESCRIPTION

Described herein are various systems, methods, and apparatus for controlling or operating an automated vehicle. While the teachings presented herein are generally directed to fully-automated or autonomous vehicles where the operator of the vehicle does little more than designate a destination, it is contemplated that the teaching presented herein are applicable to partially-automated vehicles or vehicles that are generally manually operated with some incremental amount of automation that merely assists the operator with driving.

Autonomous Guidance System

Autonomous guidance systems that operate vehicles in an autonomous mode have been proposed. However, many of these systems rely on detectable markers in the roadway so the system can determine where to steer the vehicle. Vision based systems that do not rely on detectable markers but rather rely on image processing to guide the vehicle have also been proposed. However image based systems require critical alignment of the camera in order to reliably determine distance to objects.

FIG. 1A illustrates a non-limiting example of an autonomous guidance system, hereafter referred to as the system 110A, which operates a vehicle 10A in an autonomous mode that autonomously controls, among other things, the steering-direction, and the speed of the vehicle 10A without intervention on the part of an operator (not shown). In general, the means to change the steering-direction, apply brakes, and control engine power for the purpose of autonomous vehicle control are known so these details will not be explained herein. The disclosure that follows is general directed to how radar and image processing can be cooperatively used to improve autonomous control of the vehicle 10A, in particular how maps used to determine where to steer the vehicle can be generated, updated, and otherwise improved for autonomous vehicle guidance.

The vehicle 10A is equipped with a sensor assembly, hereafter the assembly 20A, which is shown in this example located in an interior compartment of the vehicle 10A behind a window 12A of the vehicle 10A. While an automobile is illustrated, it will be evident that the assembly 20A may also be suitable for use on other vehicles such as heavy duty on-road vehicles like semi-tractor-trailers, and off-road vehicles such as construction equipment. In this non-limiting example, the assembly 20A is located behind the windshield and forward of a rearview mirror 14A so is well suited to detect an object 16A in an area 18A forward of the vehicle 10A. Alternatively, the assembly 20A may be positioned to ‘look’ through a side or rear window of the vehicle 10A to observe other areas about the vehicle 10A, or the assembly may be integrated into a portion of the vehicle body in an unobtrusive manner. It is emphasized that the assembly 20A is advantageously configured to be mounted on the vehicle 10A in such a way that it is not readily noticed. That is, the assembly 20A is more aesthetically pleasing than previously proposed autonomous systems that mount a sensor unit in a housing that protrudes above the roofline of the vehicle on which it is mounted. As will become apparent in the description that follows, the assembly 20A includes features particularly directed to overcoming problems with detecting small objects.

FIG. 2 illustrates a non-limiting example of a block diagram of the system 110A, i.e. a block diagram of the assembly 20A. The assembly 20A may include a controller 120A that may include a processor such as a microprocessor or other control circuitry such as analog and/or digital control circuitry including an application specific integrated circuit (ASIC) for processing data as should be evident to those in the art. The controller 120A may include memory, including non-volatile memory, such as electrically erasable programmable read-only memory (EEPROM) for storing one or more routines, thresholds and captured data. The one or more routines may be executed by the processor to perform steps for determining if signals received by the controller 120A for detecting the object 16A as described herein.

The controller 120A includes a radar module 30A for transmitting radar signals through the window 12A to detect an object 16A through the window 12A and in an area 18A about the vehicle 10A. The radar module 30A outputs a reflection signal 112A indicative of a reflected signal 114A reflected by the object 16A. In the example, the area 18A is shown as generally forward of the vehicle 10A and includes a radar field of view defined by dashed lines 150A. The radar module 30A receives reflected signal 114A reflected by the object 16A when the object 16A is located in the radar field of view.

The controller 120A also includes a camera module 22A for capturing images through the window 12A in a camera field of view defined by dashed line 160A. The camera module 22A outputs an image signal 116A indicative of an image of the object 16A in the area about a vehicle. The controller 120A is generally configured to detect one or more objects relative to the vehicle 10A. Additionally, the controller 120A may have further capabilities to estimate the parameters of the detected object(s) including, for example, the object position and velocity vectors, target size, and classification, e.g., vehicle verses pedestrian. In additional to autonomous driving, the assembly 20A may be employed onboard the vehicle 10A for automotive safety applications including adaptive cruise control (ACC), forward collision warning (FCW), and collision mitigation or avoidance via autonomous braking and lane departure warning (LDW).

The controller 120A or the assembly 20A advantageously integrates both radar module 30A and the camera module 22A into a single housing. The integration of the camera module 22A and the radar module 30A into a common single assembly (the assembly 20A) advantageously provides a reduction in sensor costs. Additionally, the camera module 22A and radar module 30A integration advantageously employs common or shared electronics and signal processing as shown in FIG. 2A. Furthermore, placing the radar module 30A and the camera module 22A in the same housing simplifies aligning these two parts so a location of the object 16A relative to the vehicle 10A base on a combination of radar and image data (i.e.—radar-camera data fusion) is more readily determined.

The assembly 20A may advantageously employ a housing 100A comprising a plurality of walls as shown in FIGS. 3A and 4A, according to one embodiment. The controller 120A that may incorporate a radar-camera processing unit 50A for processing the captured images and the received reflected radar signals and providing an indication of the detection of the presence of one or more objects detected in the coverage zones defined by the dashed lines 150A and the dashed lines 160A.

The controller 120A may also incorporate or combine the radar module 30A, the camera module 22A, the radar-camera processing unit 50A, and a vehicle control unit 72A. The radar module 30A and camera module 22A both communicate with the radar-camera processing unit 50A to process the received radar signals and camera generated images so that the sensed radar and camera signals are useful for various radar and vision functions. The vehicle control unit 72A may be integrated within the radar-camera processing unit or may be separate therefrom. The vehicle control unit 72A may execute any of a number of known applications that utilize the processed radar and camera signals including, but not limited to autonomous vehicle control, ACC, FCW, and LDW.

The camera module 22A is shown in FIG. 2A including both the optics 24A and an imager 26A. It should be appreciated that the camera module 22A may include a commercially available off the shelf camera for generating video images. For example, the camera module 22A may include a wafer scale camera, or other image acquisition device. Camera module 22A receives power from the power supply 58A of the radar-camera processing unit 50A and communicates data and control signals with a video microcontroller 52A of the radar-camera processing unit 50A.

The radar module 30A may include a transceiver 32A coupled to an antenna 48A. The transceiver 32A and antenna 48A operate to transmit radar signals within the desired coverage zone or beam defined by the dashed lines 150A and to receive reflected radar signals reflected from objects within the coverage zone defined by the dashed lines 150A. The radar module 30A may transmit a single fan-shaped radar beam and form multiple receive beams by receive digital beam-forming, according to one embodiment. The antenna 48A may include a vertical polarization antenna for providing vertical polarization of the radar signal which provides good propagation over incidence (rake) angles of interest for the windshield, such as a seventy degree (70°) incidence angle. Alternately, a horizontal polarization antenna may be employed; however, the horizontal polarization is more sensitive to the RF properties and parameters of the windshield for high incidence angle.

The radar module 30A may also include a switch driver 34A coupled to the transceiver 32A and further coupled to a programmable logic device (PLD 36A). The programmable logic device (PLD) 36A controls the switch driver in a manner synchronous with the analog-to-digital converter (ADC 38A) which, in turn, samples and digitizes signals received from the transceiver 32A. The radar module 30A also includes a waveform generator 40A and a linearizer 42A. The radar module 30A may generate a fan-shaped output which may be achieved using electronic beam forming techniques. One example of a suitable radar sensor operates at a frequency of 76.5 gigahertz. It should be appreciated that the automotive radar may operate in one of several other available frequency bands, including 24 GHz ISM, 24 GHz UWB, 76.5 GHz, and 79 GHz.

The radar-camera processing unit 50A is shown employing a video microcontroller 52A, which includes processing circuitry, such as a microprocessor. The video microcontroller 52A communicates with memory 54A which may include SDRAM and flash memory, amongst other available memory devices. A device 56A characterized as a debugging USB2 device is also shown communicating with the video microcontroller 52A. The video microcontroller 52A communicates data and control with each of the radar module 30A and camera module 22A. This may include the video microcontroller 52A controlling the radar module 30A and camera module 22A and includes receiving images from the camera module 22A and digitized samples of the received reflected radar signals from the radar module 30A. The video microcontroller 52A may process the received radar signals and camera images and provide various radar and vision functions. For example, the radar functions executed by video microcontroller 52A may include radar detection 60A, tracking 62A, and threat assessment 64A, each of which may be implemented via a routine, or algorithm. Similarly, the video microcontroller 52A may implement vision functions including lane tracking function 66A, vehicle detection 68A, and pedestrian detection 70A, each of which may be implemented via routines or algorithms. It should be appreciated that the video microcontroller 52A may perform various functions related to either radar or vision utilizing one or both of the outputs of the radar module 30A and camera module 22A.

The vehicle control unit 72A is shown communicating with the video microcontroller 52A by way of a controller area network (CAN) bus and a vision output line. The vehicle control unit 72A includes an application microcontroller 74A coupled to memory 76A which may include electronically erasable programmable read-only memory (EEPROM), amongst other memory devices. The memory 76A may also be used to store a map 122A of roadways that the vehicle 10A may travel. As will be explained in more detail below, the map 122A may be created and or modified using information obtained from the radar module 30A and/or the camera module 22A so that the autonomous control of the vehicle 10A is improved. The vehicle control unit 72A is also shown including an RTC watchdog 78A, temperature monitor 80A, and input/output interface for diagnostics 82A, and CAN/HW interface 84A. The vehicle control unit 72A includes a twelve volt (12V) power supply 86A which may be a connection to the vehicle battery. Further, the vehicle control unit 72A includes a private CAN interface 88A and a vehicle CAN interface 90A, both shown connected to an electronic control unit (ECU) that is connected to an ECU connector 92A. Those in the art will recognize that vehicle speed, braking, steering, and other functions necessary for autonomous operation of the vehicle 10A can be performed by way of the ECU connector 92A.

The vehicle control unit 72A may be implemented as a separate unit integrated within the assembly 20A or may be located remote from the assembly 20A and may be implemented with other vehicle control functions, such as a vehicle engine control unit. It should further be appreciated that functions performed by the vehicle control unit 72A may be performed by the video microcontroller 52A, without departing from the teachings of the present invention.

The camera module 22A generally captures camera images of an area in front of the vehicle 10A. The radar module 30A may emit a fan-shaped radar beam so that objects generally in front of the vehicle reflect the emitted radar back to the sensor. The radar-camera processing unit 50A processes the radar and vision data collected by the corresponding camera module 22A and radar module 30A and may process the information in a number of ways. One example of processing of radar and camera information is disclosed in U.S. Patent Application Publication No. 2007/0055446, which is assigned to the assignee of the present application, the disclosure of which is hereby incorporated herein by reference.

Referring to FIGS. 3 and 4, the assembly 20A is generally illustrated having a housing 100A containing the various components thereof. The housing 100A may include a polymeric or metallic material having a plurality of walls that generally contain and enclose the components therein. The housing 100A has an angled surface 102A shaped to conform to the interior shape of the window 12A. Angled surface 102A may be connected to window 12A via an adhesive, according to one embodiment. According to other embodiments, housing 100A may otherwise be attached to window 12A or to another location behind the window 12A within the passenger compartment of the vehicle 10A.

The assembly 20A has the camera module 22A generally shown mounted near an upper end and the radar module 30A is mounted below. However, the camera module 22A and radar module 30A may be located at other locations relative to each other. The radar module 30A may include an antenna 48A that is vertical oriented mounted generally at the forward side of the radar module 30A for providing a vertical polarized signal. The antenna 48A may be a planar antenna such as a patch antenna. A glare shield 28A is further provided shown as a lower wall of the housing 100A generally below the camera module 22A. The glare shield 28A generally shields light reflection or glare from adversely affecting the light images received by the camera module 22A. This includes preventing glare from reflecting off of the vehicle dash or other components within the vehicle and into the imaging view of the camera module 22A. Additionally or alternately, an electromagnetic interference (EMI) shield may be located in front or below the radar module 30A. The EMI shield may generally be configured to constrain the radar signals to a generally forward direction passing through the window 12A, and to prevent or minimize radar signals that may otherwise pass into the vehicle 10A. It should be appreciated that the camera module 22A and radar module 30A may be mounted onto a common circuit board which, in turn, communicates with the radar-camera processing unit 50A, all housed together within the housing 100A.

Described above is an autonomous guidance system (the system 110A) that operates a vehicle 10A in an autonomous mode. The system 110A includes a camera module 22A and a radar module 30A. The camera module 22A outputs an image signal 116A indicative of an image of an object 16A in the area 18A about a vehicle 10A. The radar module 30A outputs a reflection signal 112A indicative of a reflected signal 114A reflected by the object 16A. The controller 120A may be used to generate from scratch and store a map 122A of roadways traveled by the vehicle 10A, and/or update a previously stored/generated version of the map 122A. The controller 120A may include a global-positioning-unit, hereafter the GPS 124A to provide a rough estimate of a vehicle-location 126A of the vehicle 10A relative to selected satellites (not shown).

As will become clear in the description that follows, the system 110A advantageously is able to accurately determine an object-location 128A of the object 16A relative to the vehicle 10A so that small objects that are not normally included in typical GPS based maps can be avoided by the vehicle when being autonomously operated. By way of example and not limitation, the object 16A illustrated in FIG. 1 is a small mound in the roadway, the kind of which is sometimes used to designate a lane boundary at intersections. In this non-limiting example, the object 16A could be driven over by the vehicle 10A without damage to the vehicle 10A. However, jostling of passengers by wheels of the vehicle 10A driving over the object 16A may cause undesirable motion of the vehicle 10A that may annoy passengers in the vehicle 10A, or possibly spill coffee in the vehicle 10A. Another example of a small object that may warrant some action on the part of an autonomous driving system is a rough rail-road crossing, where the system 110A may slow the vehicle 10A shortly before reaching the rail-road crossing.

In one embodiment, the controller 120A is configured to generate the map 122A of the area 18A based on the vehicle-location 126A of the vehicle 10A. That is, the controller 120A is not preloaded with a predetermined map such as those provided with a typical commercially available navigation assistance device. Instead, the controller 120A builds or generates the map 122A from scratch based on, the image signal 116A, and the reflection signal 112A and global position coordinates provide by the GPS 124A. For example, the width of the roadways traveled by the vehicle 10A may be determined from the image signal 116A, and various objects such as signs, bridges, buildings, and the like may be recorded or classified by a combination of the image signal 116A and the reflection signal.

Typically, vehicle radar systems ignore small objects detected by the radar module 30A. By way of example and not limitation, small objects include curbs, lamp-posts, mail-boxes, and the like. For general navigation systems, these small objects are typically not relevant to determining when the next turn should be made an operator of the vehicle. However, for an autonomous guidance system like the system 110A described herein, prior knowledge of small targets can help the system keep the vehicle 10A centered in a roadway, and can indicate some unexpected small object as a potential threat if an unexpected small object is detected by the system 110A. Accordingly, the controller 120A may be configured to classify the object 16A as small when a magnitude of the reflection signal 112A associated with the object 16A is less than a signal-threshold. The system may also be configured to ignore an object classified as small if the object is well away from the roadway, more than five meters (5 m) for example.

In an alternative embodiment, the controller 120A may be preprogrammed or preloaded with a predetermined map such as those provided with a typical commercially available navigation assistance device. However, as those in the art will recognize that such maps typically do not include information about all objects proximate to a roadway, for example, curbs, lamp-posts, mail-boxes, and the like. The controller 120A may be configured or programmed to determine the object-location 128A of the object 16A on the map 122A of the area 18A based on the vehicle-location 126A of the vehicle 10A on the map 122A, the image signal 116A, and the reflection signal 112A. That is, the controller 120A may add details to the preprogrammed map in order to identify various objects to assist the system 110A avoid colliding with various objects and keep the vehicle 10A centered in the lane or roadway on which it is traveling. As mention before, prior radar based system may ignore small objects. However, in this example, the controller 120A classifies the object as small when the magnitude of the reflection signal 112A associated with the object 16A is less than a signal-threshold. Accordingly, small objects such as curbs, lamp-posts, mail-boxes, and the like can be remembered by the system 110A to help the system 110A safely navigate the vehicle 10A.

It is contemplated that the accumulation of small objects in the map 122A will help the system 110A more accurately navigate a roadway that is traveled more than once. That is, the more frequently a roadway is traveled, the more detailed the map 122A will become as small objects that were previously ignored by the radar module 30A are now noted and classified as small. It is recognized that some objects are so small that it may be difficult to distinguish an actual small target from noise. As such, the controller may be configured to keep track of each time a small object is detected, but not add that small object to the map 122A until the small object has been detected multiple times. In other words, the controller classifies the object 16A as verified if the object 16A is classified as small and the object 16A is detected a plurality of occasions that the vehicle 10A passes through the area 18A. It follows that the controller 120A adds the object 16A to the map 122A after the object 16A is classified as verified after having been classified as small.

Instead of merely counting the number of times an object that is classified as small is detected, the controller 120A may be configured or programmed to determine a size of the object 16A based on the image signal 116A and the reflection signal 112A, and then classify the object 16A as verified if the object is classified as small and a confidence level assigned to the object 16A is greater than a confidence-threshold, where the confidence-threshold is based on the magnitude of the reflection signal 112A and a number of occasions that the object is detected. For example, if the magnitude of the reflection signal 112A is only a few percent below the signal-threshold used to determine that an object is small, then the object 16A may be classified as verified after only two or three encounters. However, if the magnitude of the reflection signal 112A is more than fifty percent below the signal-threshold used to determine that an object is small, then the object 16A may be classified as verified only after many encounter, eight encounters for example. As before, the controller 120A then adds the object 16A to the map 122A after the object 16A is classified as verified.

Other objects may be classified based on when they appear. For example, if the vehicle autonomously travels the same roadway every weekday to, for example, convey a passenger to work, objects such garbage cans may appear adjacent to the roadway on one particular day, Wednesday for example. The controller 120A may be configured to log the date, day of the week, and/or time of day that an object is encountered, and then look for a pattern so the presence of that object can be anticipated in the future and the system 110A can direct the vehicle 10A to give the garbage can a wide berth.

Accordingly, an autonomous guidance system (the system 110A), and a controller 120A for the system 110A is provided. The controller 120A learns the location of small objects that are not normally part of navigation maps but are a concern when the vehicle 10A is being operated in an autonomous mode. If a weather condition such as snow obscures or prevents the detection of certain objects by the camera module 22A and/or the radar module 30A, the system 110A can still direct the vehicle 10A to avoid the object 16A because the object-location 128A relative to other un-obscured objects is present in the map 122A.

Method of Automatically Controlling an Autonomous Vehicle Based on Electronic Messages from Roadside Infrastructure or Other Vehicles

Some vehicles are configured to operate automatically so that the vehicle navigates through an environment with little or no input from a driver. Such vehicles are often referred to as “autonomous vehicles”. These autonomous vehicles typically include one or more sensors that are configured to sense information about the environment. The autonomous vehicle may use the sensed information to navigate through the environment. For example, if the sensors sense that the autonomous vehicle is approaching an intersection with a traffic signal, the sensors must determine the state of the traffic signal to determine whether the autonomous vehicle needs to stop at the intersection. The traffic signal may be obscured to the sensor by weather conditions, roadside foliage, or other vehicles between the sensor and the traffic signal. Therefore, a more reliable method of determining the status of roadside infrastructure is desired.

Because portions of the driving environment may be obscured to environmental sensors, such as forward looking sensors, it is desirable to supplement sensor inputs. Presented herein is a method of operating an automatically controlled or “autonomous” vehicle wherein the vehicle receives electronic messages from various elements of the transportation infrastructure, such as traffic signals, signage, or other vehicles. The infrastructure contains wireless transmitters that broadcast information about the state of each element of the infrastructure, such as location and operational state. The information may be broadcast by a separate transmitter associated with each element of infrastructure or it may be broadcast by a central transmitter. The infrastructure information is received by the autonomous vehicle and a computer system on-board the autonomous vehicle then determines whether countermeasures are required by the autonomous vehicle and sends instructions to the relevant vehicle system, e.g. the braking system, to perform the appropriate actions.

FIG. 1B illustrates a non-limiting example of an environment in which an automatically controlled vehicle 10B, hereinafter referred to as the autonomous vehicle 10B, may operate. The autonomous vehicle 10B travels along a roadway 12B having various associated infrastructure elements. The illustrated examples of infrastructure elements include:
a traffic signaling device 14B, e.g. “stop light’. The traffic signaling device 14B transmits an electronic signal that includes information regarding the traffic signaling device's location, signal phase, e.g. direction of stopped traffic, direction of flowing traffic, left or right turn indicators active, and phase timing, i.e. time remaining until the next phase change.
a construction zone warning device 16B that may include signage, barricades, traffic barrels, barriers, or flashers. The construction zone warning device 16B transmits an electronic signal that may include information regarding the location of the construction zone, the construction zone direction, e.g. northbound lanes, the length of the construction zone, the speed limit within the construction zone, and an indication of any roadway lanes that are closed.
a stop sign 18B. The stop sign 18B transmits an electronic signal that may include information regarding the sign location, stop direction, i.e. the autonomous vehicle 10B needs to stop or cross traffic needs to stop, and number of stop directions, i.e. two or four way stop.
a railroad crossing warning device 20B. The railroad crossing warning device 20B transmits an electronic signal that may include information regarding the railroad crossing signal location and warning state.
an animal crossing zone warning device 22B, e.g. a deer area or moose crossing sign. The animal crossing zone warning device 22B transmits an electronic signal that may include information regarding the animal crossing zone location, animal crossing zone direction, e.g. southbound lanes, and animal crossing zone length
a pedestrian crossing warning device 24B. The pedestrian warning device may be a sign marking a pedestrian crossing or it may incorporate a warning system activated by the pedestrian when entering the crossing. The pedestrian crossing warning device 24B transmits an electronic signal that may include information regarding the pedestrian crossing location and warning state, e.g. pedestrian in walkway.
a school crossing warning device 26B. The school crossing warning device 26B may be a handheld sign used by a school crossing guard. A warning signal, in the form of flashing lights may be activated by the crossing guard when a child is in the crossing. The school crossing warning device 26B transmits an electronic signal that may include information regarding the school crossing warning device location and warning state.
a lane direction indicating device 28B. The lane direction indicating device 28B transmits an electronic signal that may include information regarding the lane location and a lane direction of each lane location.
a speed limiting device 30B, e.g. a speed limit sign. The speed limiting device 30B transmits an electronic signal that may include information regarding the speed zone's location, the speed zone's direction, the speed zone length, and the speed limit within the speed zone.
a no passing zone device 32B, e.g. a no passing zone sign. The no passing zone device 32B transmits an electronic signal that may include information regarding the no passing zone's location, the no passing zone's direction, and the no passing zone's length.

The environment in which the autonomous vehicle 10B operates may also include other vehicles with which the autonomous vehicle 10B may interact. The illustrated examples of other vehicles include:
a school bus 34B. The school bus 34B transmits an electronic signal that includes information regarding the school bus' location and stop signal status.
a maintenance vehicle 36B, e.g. snow plow or lane marker. The maintenance vehicle 36B transmits an electronic signal that includes information regarding the maintenance vehicle's location and the safe following distance required.
an emergency vehicle 38B, e.g. police car or ambulance. The emergency vehicle 38B transmits an electronic signal that includes information regarding the emergency vehicle's location, the emergency vehicle's speed, and the emergency vehicle's warning light status.

The autonomous vehicle 10B includes a computer system connected to a wireless receiver that is configured to receive the electronic messages from the transmitters associated with the infrastructure and/or other vehicles. The transmitters and receivers may be configured to communicate using any of a number of protocols, including Dedicated Short Range Communication (DSRCB) or WIFI (IEEE 802.11xB). The transmitters and receivers may alternatively be transceivers allowing two-way communication between the infrastructure and/or other vehicles and the autonomous vehicle 10B. The computer system is interconnected to various sensors and actuators responsible for controlling the various systems in the autonomous vehicle 10B, such as the braking system, the powertrain system, and the steering system. The computer system may be a central processing unit or may be several distributed processors communication over a communication bus, such as a Controller Area Network (CANB) bus.

The autonomous vehicle 10B further includes a locating device configured to determine both the geographical location of the autonomous vehicle 10B as well as the vehicle speed. An example of such a device is a Global Positioning System (GPSB) receiver.

The autonomous vehicle 10B may also include a forward looking sensor 40B configured to identify objects in the forward path of the autonomous vehicle 10B. Such a sensor 40B may be a visible light camera, an infrared camera, a radio detection and ranging (RADARB) transceiver, and/or a laser imaging, detecting and ranging (LIDARB) transceiver.

FIG. 2B illustrates a non-limiting example of a method 100 of automatically operating an autonomous vehicle 10B. The method 100B includes STEP 102B, RECEIVE A MESSAGE FROM ROADSIDE INFRASTRUCTURE VIA AN ELECTRONIC RECEIVER, that include receiving a message transmitted from roadside infrastructure via an electronic receiver within the autonomous vehicle 10B. As used herein, roadside infrastructure may refer to controls, signage, sensors, or other components of the roadway 12B on which the autonomous vehicle 10B travels.

The method 100B further includes STEP 104B, PROVIDE, BY A COMPUTER SYSTEM IN COMMUNICATION WITH THE ELECTRONIC RECEIVER, INSTRUCTIONS BASED ON THE MESSAGE TO AUTOMATICALLY IMPLEMENT COUNTERMEASURE BEHAVIOR BY A VEHICLE SYSTEM, that includes providing instructions to a vehicle system to automatically implement countermeasure behavior. The instructions are sent to the vehicle system by a computer system that is in communication with the electronic receiver and the instruction are based on the information contained within a message received from the roadside infrastructure by the receiver.

FIG. 3B illustrates a first set of sub-steps that may be included in STEP 104B. This set of sub-steps are used to automatically stop the autonomous vehicle 10B when approaching a traffic signaling device 14B, e.g. stop light. SUB-STEP 1102B, DETERMINE A VEHICLE SPEED, includes determining the speed of the autonomous vehicle 10B via the locating device. SUB-STEP 1104B, DETERMINE THE SIGNAL PHASE IN A CURRENT VEHICLE PATH, includes determining the signal phase, e.g. red, yellow, green, of the traffic signaling device 14B along the autonomous vehicle's desired path. SUB-STEP 1106B, DETERMINE A DISTANCE BETWEEN THE VEHICLE AND THE DEVICE LOCATION, includes calculating the distance between the current location of the autonomous vehicle 10B determined by the autonomous vehicle's locating device and the location of the traffic signaling device 14B contained within the message received from the traffic signaling device 14B. SUB-STEP 1108B, PROVIDE, BY THE COMPUTER SYSTEM, INSTRUCTIONS TO THE BRAKING SYSTEM TO APPLY VEHICLE BRAKES BASED ON THE VEHICLE SPEED, THE SIGNAL PHASE OF THE CURRENT VEHICLE PATH, AND THE DISTANCE BETWEEN THE VEHICLE AND THE DEVICE LOCATION, includes sending instructions to the vehicle braking system to apply brakes when it is determined that the autonomous vehicle 10B will need to come to a stop at the intersection controlled by the traffic signaling device 14B based on the traffic signal phase, the time remaining before the next phase change, the vehicle speed, the distance between the autonomous vehicle and the traffic signaling device location. The forward looking sensor 40B may also be employed to adjust the braking rate to accommodate other vehicles already stopped at the intersection controlled by the traffic signaling device 14B.

FIG. 4B illustrates a second set of sub-steps that may be included in STEP 104B. This set of sub-steps are used to automatically control the autonomous vehicle 10B when approaching a construction zone. SUB-STEP 2102B, DETERMINE A VEHICLE SPEED, includes determining the speed of the autonomous vehicle via the locating device. SUB-STEP 2104B, DETERMINE A LATERAL VEHICLE LOCATION WITHIN A ROADWAY, includes determine the lateral vehicle location within a roadway 12B via the locating device so that it may be determined in which road lane the autonomous vehicle 10B is traveling. SUB-STEP 2106B, DETERMINE A DISTANCE BETWEEN THE VEHICLE AND THE ZONE LOCATION, includes calculating the distance between the current location of the autonomous vehicle 10B determined by the autonomous vehicle's locating device and the location of the construction zone contained within the message received from the construction zone warning device 16B. SUB-STEP 2108B, DETERMINE A DIFFERENCE BETWEEN THE VEHICLE SPEED AND THE ZONE SPEED LIMIT, includes calculating the difference between the speed of the autonomous vehicle 10B determined by the autonomous vehicle's locating device and the speed limit of the construction zone contained within the message received from the construction zone warning device 16B. SUB-STEP 2110B, PROVIDE, BY THE COMPUTER SYSTEM, INSTRUCTIONS TO THE BRAKING SYSTEM TO APPLY VEHICLE BRAKES BASED ON THE VEHICLE SPEED, THE ZONE SPEED LIMIT, AND THE DISTANCE BETWEEN THE VEHICLE AND THE ZONE LOCATION, includes sending instructions to the vehicle braking system to apply brakes when it is determined that the autonomous vehicle 10B will need to come to a reduce speed before reaching the construction zone based on the vehicle speed, the speed limit within the construction zone, and the distance between the autonomous vehicle 10B and the construction zone location. SUB-STEP 2112B, DETERMINE A STEERING ANGLE BASED ON THE LATERAL VEHICLE LOCATION, THE LANE CLOSURES, THE VEHICLE SPEED, AND THE DISTANCE BETWEEN THE VEHICLE AND THE ZONE LOCATION, includes determining a steering angle to change lanes from a lane that is closed in the construction zone to a lane that is open within the construction zone when it is determined by the lateral location of the autonomous vehicle that the autonomous vehicle 10B is traveling in a lane that is indicated as closed in the message received from the construction zone warning device 16B. SUB-STEP 2114B, PROVIDE, BY THE COMPUTER SYSTEM, INSTRUCTIONS TO THE STEERING SYSTEM TO ADJUST A VEHICLE PATH BASED ON THE STEERING ANGLE, includes sending instructions from the computer system to the steering system to adjust the vehicle path based on the steering angle determined in SUB-STEP 2112B. SUB-STEP 2116B, PROVIDE, BY THE COMPUTER SYSTEM, INSTRUCTIONS TO THE POWERTRAIN SYSTEM TO ADJUST THE VEHICLE SPEED SO THAT THE VEHICLE SPEED IS LESS THAN OR EQUAL TO THE ZONE SPEED LIMIT, includes sending instructions from the computer system to the powertrain system to adjust the vehicle speed so that the vehicle speed is less than or equal to the speed limit for the construction zone contained in the message received from the construction zone warning device 16B.

FIG. 5B illustrates a third set of sub-steps that may be included in STEP 104B. This set of sub-steps are used to automatically stop the autonomous vehicle 10B when approaching a stop sign 18B. SUB-STEP 3102B, DETERMINE A VEHICLE SPEED, includes determining the speed of the autonomous vehicle 10B via the locating device. SUB-STEP 3104B, DETERMINE THE STOP DIRECTION OF A CURRENT VEHICLE PATH, includes determining whether the autonomous vehicle 10B needs to stop at the intersection controlled by the stop sign 18B based on the current direction of travel determined by the autonomous vehicle's locating device and direction of traffic required to stop reported in the message received from the stop sign transmitter. SUB-STEP 3106B, DETERMINE A DISTANCE BETWEEN THE VEHICLE AND THE SIGN LOCATION, includes calculating the distance between the current location of the autonomous vehicle determined by the autonomous vehicle's locating device and the location of the stop sign 18B contained within the message received from the stop sign transmitter. SUB-STEP 3108B, PROVIDE, BY THE COMPUTER SYSTEM, INSTRUCTIONS TO THE BRAKING SYSTEM TO APPLY VEHICLE BRAKES BASED ON THE VEHICLE SPEED, THE SIGNAL PHASE OF THE CURRENT VEHICLE PATH, AND THE DISTANCE BETWEEN THE VEHICLE AND THE SIGN LOCATION, includes sending instructions to the vehicle braking system to apply brakes when it is determined that the autonomous vehicle 10B will need to come to a stop at the intersection controlled by the stop sign 18B based on the direction of traffic required to stop reported in the message received from the stop sign transmitter, the vehicle speed, and the distance between the autonomous vehicle 10B and the stop sign 18B location. The forward looking sensor 40B may also be employed to adjust the braking rate to accommodate other vehicles already stopped at the intersection controlled by the stop sign 18B.

FIG. 6B illustrates a fourth set of sub-steps that may be included in STEP 104B. This set of sub-steps is used to automatically stop the autonomous vehicle 10B when approaching a railroad crossing. SUB-STEP 4102B, DETERMINE A VEHICLE SPEED, includes determining the speed of the autonomous vehicle via the locating device. SUB-STEP 4104B, DETERMINE THE WARNING STATE, includes determining the warning state of the railroad crossing warning device 20B. SUB-STEP 4106B, DETERMINE A DISTANCE BETWEEN THE VEHICLE AND THE DEVICE LOCATION, includes calculating the distance between the current location of the autonomous vehicle 10B determined by the autonomous vehicle's locating device and the location of the railroad crossing warning device 20B contained within the message received from the railroad crossing warning device 20B. SUB-STEP 4108B, PROVIDE, BY THE COMPUTER SYSTEM, INSTRUCTIONS TO THE BRAKING SYSTEM TO APPLY VEHICLE BRAKES BASED ON THE VEHICLE SPEED, WARNING STATE, AND THE DISTANCE BETWEEN THE VEHICLE AND THE DEVICE LOCATION, includes sending instructions to the vehicle braking system to apply brakes when it is determined that the autonomous vehicle 10B will need to come to a stop at the railroad crossing based on the warning state, the vehicle speed, the distance between the autonomous vehicle 10B and the railroad crossing warning device location. The forward looking sensor 40B may also be employed to adjust the braking rate to accommodate other vehicles already stopped at the railroad crossing.

FIG. 7B illustrates a fifth set of sub-steps that may be included in STEP 104B. This set of sub-steps are used to automatically increase the field of view of the forward looking sensor 40B when the autonomous vehicle is approaching an animal crossing zone. SUB-STEP 5102B, PROVIDE, BY THE COMPUTER SYSTEM, INSTRUCTIONS TO THE FORWARD LOOKING SENSOR TO WIDEN A FIELD OF VIEW SO AS TO INCLUDE AT LEAST BOTH ROAD SHOULDERS WITHIN THE FIELD OF VIEW, includes sending instructions to the forward looking sensor 40B to widen the field of view of the sensor 40B to include at least both shoulders of the roadway 12B when the receiver receives a message from an animal crossing zone warning device 22B and it is determined that the autonomous vehicle 10B has entered the animal crossing zone. Increasing the field of view will increase the likelihood that the forward looking sensor 40B will detect an animal entering the roadway 12B.

FIG. 8B illustrates a sixth set of sub-steps that may be included in STEP 104B. This set of sub-steps are used to automatically increase the field of view of the forward looking sensor 40B when the autonomous vehicle is approaching a pedestrian crosswalk. SUB-STEP 6102B, PROVIDE, BY THE COMPUTER SYSTEM, INSTRUCTIONS TO THE FORWARD LOOKING SENSOR TO WIDEN A FIELD OF VIEW SO AS TO INCLUDE AT LEAST BOTH ROAD SHOULDERS WITHIN THE FIELD OF VIEW, includes sending instructions to the forward looking sensor 40B to widen the field of view of the sensor 40B to include at least both shoulders of the roadway 12B when the receiver receives a message from a pedestrian crossing warning device 24B and it is determined that the autonomous vehicle 10B is near the crosswalk controlled by the pedestrian crossing warning device 24B. Increasing the field of view will increase the likelihood that the forward looking sensor 40B will detect pedestrian entering the crosswalk. SUB-STEP 6104B, DETERMINE A VEHICLE SPEED, includes determining the speed of the autonomous vehicle 10B via the locating device. SUB-STEP 6106B, DETERMINE A DISTANCE BETWEEN THE VEHICLE AND THE DEVICE LOCATION, includes calculating the distance between the current location of the autonomous vehicle 10B determined by the autonomous vehicle's locating device and the location of the pedestrian crossing warning device 24B contained within the message received from the pedestrian crossing warning device 24B. SUB-STEP 6108B, PROVIDE, BY THE COMPUTER SYSTEM, INSTRUCTIONS TO THE BRAKING SYSTEM TO APPLY VEHICLE BRAKES BASED ON THE VEHICLE SPEED, WARNING STATE, AND THE DISTANCE BETWEEN THE VEHICLE AND THE CROSSING LOCATION, includes sending instructions to the autonomous vehicle 10B braking system to apply brakes when it is determined that the autonomous vehicle 10B will need to come to a stop at the crosswalk based on the warning state, the vehicle speed, the distance between the autonomous vehicle and the crosswalk location. The forward looking sensor 40B may also be employed to adjust the braking rate to accommodate other vehicles already stopped at the crosswalk.

FIG. 9B illustrates a seventh set of sub-steps that may be included in STEP 104B. This set of sub-steps are used to automatically stop the autonomous vehicle when approaching a school crossing. SUB-STEP 7102B, DETERMINE A VEHICLE SPEED, includes determining the speed of the autonomous vehicle 10B via the locating device. SUB-STEP 7104B, DETERMINE A LATERAL LOCATION OF THE DEVICE LOCATION WITHIN A ROADWAY, includes determining the lateral position of the school crossing warning device location within the roadway 12B based on the device location reported in the message received from the school crossing warning device 26B by the receiver. If it is determined that the lateral location of the school crossing warning device 26B is within the roadway 12B, the autonomous vehicle 10B will be instructed to stop regardless of the warning state received from the school crossing warning device 26B. This is to ensure that failure to activate the warning state by the crossing guard operating the school crossing warning device 26B will not endanger students in the school crossing. SUB-STEP 7106B, DETERMINE A DISTANCE BETWEEN THE VEHICLE AND THE DEVICE LOCATION, includes calculating the distance between the current location of the autonomous vehicle 10B determined by the autonomous vehicle's locating device and the location of the school crossing warning device 26B contained within the message received from the school crossing warning device 26B. SUB-STEP 7108B, PROVIDE, BY THE COMPUTER SYSTEM, INSTRUCTIONS TO THE BRAKING SYSTEM TO APPLY VEHICLE BRAKES BASED ON DATA SELECTED FROM THE GROUP CONSISTING OF: A VEHICLE SPEED, THE LATERAL LOCATION, THE WARNING STATE, AND THE DISTANCE BETWEEN THE VEHICLE AND THE DEVICE LOCATION, includes sending instructions to the vehicle braking system to apply brakes when it is determined that the autonomous vehicle 10B will need to come to a stop at the school crossing based on the warning state and/or lateral location of the school crossing warning device 26B, the vehicle speed, the distance between the autonomous vehicle 10B and the location of the school crossing warning device 26B. The forward looking sensor 40B may also be employed to adjust the braking rate to accommodate other vehicles already stopped at the crossing.

FIG. 10B illustrates a eighth set of sub-steps that may be included in STEP 104B. This set of sub-steps are used to automatically update the roadway mapping system to accommodate temporary lane direction changes. Sub-step 8102B, PROVIDE, BY THE COMPUTER SYSTEM, INSTRUCTIONS TO THE ROADWAY MAPPING SYSTEM TO DYNAMICALLY UPDATE THE ROADWAY MAPPING SYSTEM'S LANE DIRECTION INFORMATION, includes providing by the instructions from the computer system to the roadway mapping system to dynamically update the roadway mapping system's lane direction information based on information received by the receiver from the lane direction indicating device 28B. As used herein, a lane direction indicating device 28B controls the direction of travel of selected roadway lanes, such as roadway lanes that are reversed to accommodate heavy traffic during rush hours or at entrances and exits of large sporting events.

FIG. 11B illustrates a ninth set of sub-steps that may be included in STEP 104B. This set of sub-steps are used to automatically set the vehicle speed to match the speed limit of the section of roadway 12B on which the autonomous vehicle 10B is travelling. SUB-STEP 9102B, DETERMINE A VEHICLE SPEED, includes determining the speed of the autonomous vehicle 10B via the locating device. SUB-STEP 9104B, DETERMINE A DISTANCE BETWEEN THE VEHICLE AND THE SPEED ZONE LOCATION, includes calculating the distance between the current location of the autonomous vehicle 10B determined by the autonomous vehicle's locating device and the location of the speed zone contained within the message received from the speed limiting device 30B. SUB-STEP 9106B, DETERMINE A DIFFERENCE BETWEEN THE VEHICLE SPEED AND THE ZONE SPEED LIMIT, includes calculating the difference between the speed of the autonomous vehicle 10B determined by the autonomous vehicle's locating device and the speed limit of the speed zone contained within the message received from the speed limiting device 30B. SUB-STEP 9108B, PROVIDE, BY THE COMPUTER SYSTEM, INSTRUCTIONS TO THE POWERTRAIN SYSTEM TO ADJUST THE VEHICLE SPEED SO THAT THE VEHICLE SPEED IS LESS THAN OR EQUAL TO THE ZONE SPEED LIMIT, includes sending instructions from the computer system to the powertrain system to adjust the vehicle speed so that the vehicle speed is less than or equal to the speed limit for the speed zone contained in the message received from the speed limiting device 30B.

FIG. 11B illustrates a tenth set of sub-steps that may be included in STEP 104B. This set of sub-steps are used to automatically inhibit passing of another vehicle if the passing maneuver cannot be completed before the autonomous vehicle enters a no passing zone. Sub-step 10102B, DETECT ANOTHER VEHICLE AHEAD OF THE VEHICLE VIA THE FORWARD LOOKING SENSOR, includes detecting the presence of another vehicle in the same traffic lane ahead of the autonomous vehicle via the forward looking sensor 40B. SUB-STEP 10104B, DETERMINE A VEHICLE SPEED, includes determining the speed of the autonomous vehicle 10B via the locating device. SUB-STEP 10106B, DETERMINE AN ANOTHER VEHICLE SPEED AND A DISTANCE BETWEEN THE VEHICLE AND THE ANOTHER VEHICLE, includes determining a speed differential between the autonomous vehicle 10B and the other vehicle it is trailing via a RADAR or LIDAR based on data from the forward looking sensor 40B. SUB-STEP 10108B, DETERMINE A SAFE PASSING DISTANCE FOR OVERTAKING THE ANOTHER VEHICLE, includes calculating a safe passing distance for overtaking the other vehicle based on the vehicle speed and the speed differential. SUB-STEP 10110B, DETERMINE A DISTANCE BETWEEN THE VEHICLE AND THE NO PASSING ZONE LOCATION, includes calculating the distance between the current location of the autonomous vehicle 10B determined by the autonomous vehicle's locating device and the location of the no passing zone contained within the message received from the no passing zone device 32B, if the safe passing distance would end within the no passing zone, the method proceeds to SUB-STEPS 10112B and/or 10114B. SUB-STEP 10112B, PROVIDE, BY THE COMPUTER SYSTEM, INSTRUCTIONS TO THE POWERTRAIN SYSTEM TO ADJUST THE VEHICLE SPEED SO THAT THE VEHICLE SPEED IS LESS THAN OR EQUAL TO THE ANOTHER VEHICLE SPEED WHEN THE SAFE PASSING DISTANCE WOULD END WITHIN THE NO PASSING ZONE, includes sending instructions from the computer system to the powertrain system to adjust the vehicle speed so that the vehicle speed is less than or equal to the another vehicle speed when it is determined that the safe passing distance would end within the no passing zone. SUB-STEP 10114B, PROVIDE, BY THE COMPUTER SYSTEM, INSTRUCTIONS TO THE BRAKING SYSTEM TO ADJUST THE VEHICLE SPEED SO THAT THE VEHICLE SPEED IS LESS THAN OR EQUAL TO THE ANOTHER VEHICLE SPEED WHEN THE SAFE PASSING DISTANCE WOULD END WITHIN THE NO PASSING ZONE, includes sending instructions from the computer system to the braking system to adjust the vehicle speed so that the vehicle speed is less than or equal to the another vehicle speed when it is determined that the safe passing distance would end within the no passing zone and that the speed differential between the vehicles exceeds the ability of the speed to be adjusted by the autonomous vehicle's powertrain system alone.

FIG. 13B illustrates a non-limiting example of a method 200B of automatically operating a autonomous vehicle. The method 200B includes STEP 202B, RECEIVE A MESSAGE FROM ANOTHER VEHICLE VIA AN ELECTRONIC RECEIVER, that includes receiving a message transmitted from another vehicle via an electronic receiver within the other vehicle.

The method 200B further includes STEP 204B, PROVIDE, BY A COMPUTER SYSTEM IN COMMUNICATION WITH THE ELECTRONIC RECEIVER, INSTRUCTIONS BASED ON THE MESSAGE TO AUTOMATICALLY IMPLEMENT COUNTERMEASURE BEHAVIOR BY A VEHICLE SYSTEM, that includes providing instructions to a vehicle system to automatically implement countermeasure behavior. The instructions are sent to the vehicle system by a computer system that is in communication with the electronic receiver and the instruction are based on the information contained within a message received from the other vehicle by the receiver.

FIG. 14B illustrates a first set of sub-steps that may be included in STEP 204B. This set of sub-steps are used to automatically stop the autonomous vehicle 10B when approaching a school bus 34B that has it's stop lights activated. SUB-STEP 1202B, DETERMINE A VEHICLE SPEED, includes determining the speed of the autonomous vehicle 10B via the locating device. SUB-STEP 1204B, DETERMINE THE stop SIGNAL status, includes determining the status of the stop signal, e.g. off, caution, stop, reported in the message received by the receiver. SUB-STEP 1206B, DETERMINE A DISTANCE BETWEEN THE VEHICLE AND THE SCHOOL BUS LOCATION, includes calculating the distance between the current location of the autonomous vehicle determined by the autonomous vehicle's locating device and the location of the school bus 34B contained within the message received from the school bus transmitter. SUB-STEP 1208B, PROVIDE, BY THE COMPUTER SYSTEM, INSTRUCTIONS TO THE BRAKING SYSTEM TO APPLY VEHICLE BRAKES BASED ON THE VEHICLE SPEED, THE STOP SIGNAL STATUS, AND THE DISTANCE BETWEEN THE VEHICLE AND THE SCHOOL BUS LOCATION, includes sending instructions to the vehicle braking system to apply brakes when it is determined that the autonomous vehicle 10B will need to come to a stop at the school bus location based on the stop signal status, the vehicle speed, and the distance between the autonomous vehicle 10B and school bus location. The forward looking sensor 40B may also be employed to adjust the braking rate to accommodate other vehicles already stopped for the school bus 34B.

FIG. 15B illustrates a second set of sub-steps that may be included in STEP 204B. This set of sub-steps IS used to automatically establish a safe following distance behind a maintenance vehicle 36B. SUB-STEP 2202B, DETERMINE A DISTANCE BETWEEN THE VEHICLE AND THE MAINTENANCE VEHICLE LOCATION, includes determining the distance between the autonomous vehicle 10B and the maintenance vehicle location by comparing the location of the autonomous vehicle 10B determined by the locating device with the location of the maintenance vehicle 36B contained in the message received by the receiver. SUB-STEP 2204B, DETERMINE A DIFFERENCE BETWEEN THE SAFE FOLLOWING DISTANCE AND THE DISTANCE BETWEEN THE VEHICLE AND THE MAINTENANCE VEHICLE LOCATION, includes calculating the difference between the safe following distance contained in the message from the maintenance vehicle transmitter and the distance calculated in SUB-STEP 2202B. SUB-STEP 2206B, PROVIDE, BY THE COMPUTER SYSTEM, INSTRUCTIONS TO THE BRAKING SYSTEM TO APPLY VEHICLE BRAKES WHEN THE DIFFERENCE IS LESS THAN ZERO, includes sending instructions to the vehicle braking system to apply brakes when it is determined that the distance between the autonomous vehicle 10B and the maintenance vehicle 36B is less than the safe following distance. Sub-step 2208B, PROVIDE, BY THE COMPUTER SYSTEM, INSTRUCTIONS TO THE POWERTRAIN SYSTEM TO ADJUST A VEHICLE SPEED SO THAT THE DIFFERENCE IS LESS THAN OR EQUAL TO ZERO, includes sending instructions from the computer system to the powertrain system to adjust the vehicle speed so that the difference in the distance between the autonomous vehicle 10B and the maintenance vehicle 36B and the safe following distance is less than or equal to zero, thus maintaining the safe following distance.

FIG. 16B illustrates a second set of sub-steps that may be included in STEP 204B. This set of sub-steps are used to automatically park the autonomous vehicle 10B on the shoulder of the road so that an emergency vehicle 38B that has it's warning lights activated can safely pass the autonomous vehicle. This vehicle behavior is required by law in various states. SUB-STEP 3202B, DETERMINE A DISTANCE BETWEEN THE VEHICLE AND THE EMERGENCY VEHICLE, includes determining the distance between the autonomous vehicle 10B and the emergency vehicle location by comparing the location of the autonomous vehicle 10B determined by the locating device with the location of the emergency vehicle 38B contained in the message received by the receiver. SUB-STEP 3204B, DETERMINE A LOCATION OF AN UNOBSTRUCTED PORTION OF A ROAD SHOULDER VIA THE FORWARD LOOKING SENSOR BASED ON THE DISTANCE BETWEEN THE VEHICLE AND THE EMERGENCY VEHICLE, THE EMERGENCY VEHICLE SPEED, AND WARNING LIGHT STATUS, includes using the forward looking sensor 40B to find a unobstructed portion of the shoulder of the roadway 12B in which the autonomous vehicle 10B can park in order to allow the emergency vehicle 38B to pass safely. The unobstructed location is based on the data from the forward looking sensor 40B, the distance between the autonomous vehicle 10B and the emergency vehicle 38B, the emergency vehicle speed, and the warning light status. SUB-STEP 3206B, PROVIDE, BY THE COMPUTER SYSTEM, INSTRUCTIONS TO THE BRAKING SYSTEM TO APPLY VEHICLE BRAKES BASED ON THE DISTANCE BETWEEN THE VEHICLE AND THE EMERGENCY VEHICLE, THE EMERGENCY VEHICLE SPEED, AND THE LOCATION OF THE UNOBSTRUCTED PORTION OF THE ROAD SHOULDER, includes sending instructions to the vehicle braking system to apply brakes to stop the autonomous vehicle 10B within the unobstructed location based on the distance between the autonomous vehicle 10B and the emergency vehicle 38B, the emergency vehicle speed, and the location of the unobstructed portion of the road shoulder. The forward looking sensor 40B may also be employed to adjust the braking rate to accommodate other vehicles already stopped in the road shoulder. SUB-STEP 3208B, DETERMINE A STEERING ANGLE BASED ON THE DISTANCE BETWEEN THE VEHICLE AND THE EMERGENCY VEHICLE, THE EMERGENCY VEHICLE SPEED, AND THE LOCATION OF THE UNOBSTRUCTED PORTION OF THE ROAD SHOULDER, includes determining a steering angle based on the distance between the autonomous vehicle 10B and the emergency vehicle 38B, the emergency vehicle speed, and the location of the unobstructed portion of the road shoulder. SUB-STEP 3210B, PROVIDE, BY THE COMPUTER SYSTEM, INSTRUCTIONS TO THE STEERING SYSTEM TO ADJUST A VEHICLE PATH BASED ON THE STEERING ANGLE, includes sending instructions to the vehicle steering system to steer the autonomous vehicle 10B into the unobstructed location based on the steering angle determined in SUB-STEP 3208B. SUB-STEP 3212B, PROVIDE, BY THE COMPUTER SYSTEM, INSTRUCTIONS TO THE POWERTRAIN SYSTEM TO ADJUST A VEHICLE SPEED BASED ON THE DISTANCE BETWEEN THE VEHICLE AND THE EMERGENCY VEHICLE, THE EMERGENCY VEHICLE SPEED, AND THE LOCATION OF THE UNOBSTRUCTED PORTION OF THE ROAD SHOULDER, includes sending instructions to the vehicle powertrain system to adjust the vehicle speed based on the distance between the autonomous vehicle 10B and the emergency vehicle 38B, the emergency vehicle speed, and the location of the unobstructed portion of the road shoulder.

The embodiments described herein are described in terms of an autonomous vehicle 10B. However, elements of the embodiments may also be applied to warning systems that alert the driver to manually take these identified countermeasures.

Accordingly a method 100B of automatically operating an autonomous vehicle 10B is provided. The method 100B provides the benefits of allowing automatic control of the autonomous vehicle 10B when instances of the forward looking sensor 40B are be obscured.

Method of Automatically Controlling an Autonomous Vehicle Based on Cellular Telephone Location Information

Some vehicles are configured to operate automatically so that the vehicle navigates through an environment with little or no input from a driver. Such vehicles are often referred to as “autonomous vehicles”. These autonomous vehicles typically includes one or more forward looking sensors, such as visible light cameras, infrared cameras, radio detection and raging (RADAR) or laser imaging, detecting and ranging (LIDAR) that are configured to sense information about the environment. The autonomous vehicle may use the information from the sensors(s) to navigate through the environment. For example, the sensor(s) may be used to determine whether pedestrians are located in the vicinity of the autonomous vehicle and to determine the speed and direction, i.e. the velocity, in which the pedestrians are traveling. However, the pedestrians may be obscured to the sensor by weather conditions, roadside foliage, or other vehicles. Because portions of the driving environment may be obscured to environmental sensors, such as forward looking sensors, it is desirable to supplement sensor inputs.

Autonomous vehicle systems have been proposed and implemented that supplement sensors inputs from data communicated over a short range radio network, such as a Dedicated Short Range Communication (DSRC) transceiver, from other nearby vehicles. The transmissions from these nearby vehicles include information regarding the location and velocity of the nearby vehicles. As used herein, velocity refers to both the speed and direction of travel. However, not all objects of interest in the driving environment include DRSC transceivers, e.g. pedestrians, cyclists, older vehicles. Therefore, a more reliable method of determining the velocity of nearby pedestrians, cyclists, and/or older vehicles is desired.

Presented herein is a method of operating an automatically controlled or “autonomous” vehicle wherein the autonomous vehicle receives electronic messages from nearby cellular telephones contain information regarding the location of the cellular telephone. The autonomous vehicle receives this information and a computer system on-board the autonomous vehicle then determines the location and velocity of the cellular telephone and since the cellular telephone is likely carried by a pedestrian, cyclist, or another vehicle, the computer system determines the location and velocity of nearby pedestrians, cyclists, or/or other vehicles. The computer system then determines whether countermeasures are required by the autonomous vehicle to avoid a collision and sends instructions to the relevant vehicle system, e.g. the braking system, to perform the appropriate actions. Countermeasures may be used to avoid a collision with another vehicle, pedestrian, or cyclist. Countermeasures may include activating the braking system to stop or slow the autonomous vehicle,

FIG. 1C illustrates a non-limiting example of an environment in which an automatically controlled vehicle 10C, hereinafter referred to as the autonomous vehicle 10C, may operate. The autonomous vehicle 10C includes a computer system connected to a wireless receiver that is configured to receive electronic messages 12C containing location information from a nearby cellular telephone 14C. The receiver may be configured to receive the location information directly from the nearby cellular telephone 14C or the receiver may receive the location information in near-real time from a central processor and transmitter (not shown) containing a database of cellular telephone location information based on the current location 16C of the autonomous vehicle 10C reported to the central processor by an electronic massage from the autonomous vehicle 10C. The location information for the cellular telephone 14C may be generated by a Global Positioning Satellite (GPS) receiver (not shown) in the cellular telephone 14C, may be generated by the cellular telephone network based on signal time of arrival (TOA) to several cellular phone towers, or may be based on a hybrid method using both GPS and TOA. These and other methods of determining cellular telephone location are well known to those skilled in the art.

The computer system is interconnected to various sensors and actuators (not shown) responsible for controlling the various systems in the autonomous vehicle 10C, such as the braking system, the powertrain system, and the steering system. The computer system may be a central processing unit or may be several distributed processors communication over a communication bus, such as a Controller Area Network (CAN) bus.

The autonomous vehicle 10C further includes a locating device configured to determine both the current location 16C of the autonomous vehicle 10C as well as the vehicle velocity 18C. As used herein, vehicle velocity 18C indicates both vehicle speed and direction of vehicle travel. An example of such a device is a Global Positioning System (GPS) receiver. The autonomous vehicle 10C also includes a mapping system to determine the current location 16C of the autonomous vehicle 10C relative to the roadway. The design and function of these location devices and mapping systems are well known to those skilled in the art.

Receiving location information from cellular telephone 14C provides some advantages over receiving location information from a dedicated short range transceiver, such as a Dedicated Short Range Communication (DSRC) transceiver in a scheme typically referred to as Vehicle to Vehicle communication (V2V). One advantage is that cellular phone with location capabilities are currently more ubiquitous than DSRC transceivers, since most vehicle drivers and/or vehicle passenger are in possession of a cellular telephone 14C. cellular telephone 14C with location technology are also built into many vehicles, e.g. ONSTAR® communication systems in vehicles manufactured by the General Motors Company or MBRACE® communication systems in vehicles marketed by Mercedes-Benz USA, LLC. Another advantage is that cellular telephone 14C that report location information to the autonomous vehicle 10C are also carried by a pedestrian 20C and/or a cyclist 22C, allowing the autonomous vehicle 10C to automatically take countermeasures based on their location. The pedestrian 20C and/or the cyclist 22C are unlikely to carry a dedicated transceiver, such as a DSRC transceiver. Location information from cellular telephone 14C may also be reported from non-roadway vehicles. For example, the location and velocity of a locomotive train (not shown) crossing the path of the autonomous vehicle 10C at a railroad crossing may be detected by the transmissions of a cellular telephone carried by the engineer or conductor on the locomotive.

As shown in FIG. 1C, a cellular telephone 14C may be carried e.g. by a pedestrian 20C, a cyclist 22C, or an other vehicle 24C. This cellular telephone 14C transmits location information that may be used to infer the location 26C of the pedestrian 20C, the cyclist 22C, or the other vehicle 24C. After receiving at least two messages from the cellular telephone 14C, the computer system can calculate the velocity 28C of the cellular telephone 14C and infer the velocity of the pedestrian 20C, cyclist 22C, or other vehicle 24C. Based on the location 26C and velocity 28C of the cellular telephone 14C and the current location 16C and velocity 18C of the autonomous vehicle 10C, the computer system can send instructions to the various vehicle systems, such as the braking system, the steering system, and/or the powertrain system to take countermeasures to avoid convergence of the path of the cellular telephone 14C and the autonomous vehicle 10C that would result in a collision between the autonomous vehicle 10C and the pedestrian 20C, the cyclist 22C, or the other vehicle 24C.

FIG. 2C illustrates a non-limiting example of a method 100C of automatically operating an autonomous vehicle 10C. The method 100C includes STEP 102C, RECEIVE A MESSAGE VIA AN ELECTRONIC RECEIVER INDICATING THE LOCATION OF A CELLULAR TELEPHONE PROXIMATE TO THE VEHICLE. STEP 102C includes receiving a message indicating the current location of a cellular telephone 14C proximate to the autonomous vehicle 10C via an electronic receiver within the autonomous vehicle 10C. As used herein, proximate means within a radius 500 meters or less.

STEP 104C, DETERMINE A VELOCITY OF THE CELLULAR TELEPHONE BASED ON CHANGES IN LOCATION OVER A PERIOD OF TIME, includes determining a velocity 28C of the cellular telephone 14C based on changes in location 26C over a period of time.

STEP 106C, PROVIDE, BY A COMPUTER SYSTEM IN COMMUNICATION WITH THE ELECTRONIC RECEIVER, INSTRUCTIONS BASED ON THE LOCATION AND VELOCITY OF THE CELLULAR TELEPHONE TO AUTOMATICALLY IMPLEMENT COUNTERMEASURE BEHAVIOR BY A VEHICLE SYSTEM, includes providing instructions to a vehicle system to automatically implement countermeasure behavior based on the location 26C and velocity 28C of the cellular telephone 14C and further based on the current location 16C and velocity 18C of the autonomous vehicle 10C. The instructions are sent to the vehicle system, e.g. the braking system, by a computer system that is in communication with the electronic receiver and the instruction are based on the location 26C and velocity 28C of the cellular telephone 14C and further based on the current location 16C and velocity 18C of the autonomous vehicle 10C.

FIG. 3C illustrates a non-limiting example of optional steps that may be included in the method 100C. STEP 108C, DETERMINE A VEHICLE VELOCITY, includes determining the velocity 18C of the autonomous vehicle 10C via the locating device. Step 110C, COMPARE THE VEHICLE VELOCITY WITH THE CELLULAR TELEPHONE VELOCITY, includes comparing the vehicle velocity 18C determined in STEP 108C with the cellular telephone velocity 28C determined in STEP 104C. STEP 112C, DETERMINE WHETHER A CONCURRENCE BETWEEN THE VEHICLE LOCATION AND THE CELLULAR TELEPHONE LOCATION WILL OCCUR, includes determining whether the projected path of the autonomous vehicle 10C based on the current location 16C and velocity 18C and the projected path of the cellular telephone 14C based on the location 26C and velocity 28C of the cellular telephone 14C will intersect resulting in a concurrence between the current location 16C and the cellular telephone location 26C that would indicate a collision between the autonomous vehicle 10C and the carrier (20C, 22C, 24C) of the cellular telephone 14C.

STEP 114C, PROVIDE, BY THE COMPUTER SYSTEM, INSTRUCTIONS TO THE BRAKING SYSTEM TO APPLY VEHICLE BRAKES, includes providing instructions to the braking system to apply the brakes to slow or stop the autonomous vehicle 10C in order to avoid a collision between the autonomous vehicle 10C and the carrier (20C, 2C, 24C) of the cellular telephone 14C if it is determined in STEP 112C that the concurrence between the current location 16C and the cellular telephone location 26C will occur.

STEP 116C, PROVIDE, BY THE COMPUTER SYSTEM, INSTRUCTIONS TO THE POWERTRAIN SYSTEM TO ADJUST THE VEHICLE VELOCITY, includes providing instructions to the powertrain system to adjust the vehicle velocity 18C by slowing or accelerating the autonomous vehicle 10C to in order to avoid a collision between the autonomous vehicle 10C and the carrier (20C, 22C, 24C) of the cellular telephone 14C if it is determined in STEP 112C that the concurrence between the current location 16C and the cellular telephone location 26C will occur.

STEP 118C, DETERMINE A STEERING ANGLE TO AVOID THE CONCURRENCE, includes determining a steering angle to avoid the concurrence if it is determined in STEP 112C that the concurrence between the current location 16C and the cellular telephone location 26C will occur. STEP 120C, PROVIDE, BY THE COMPUTER SYSTEM, INSTRUCTIONS TO THE STEERING SYSTEM TO ADJUST A VEHICLE PATH BASED ON THE STEERING ANGLE, includes providing instructions to the steering system to adjust a vehicle path to avoid the concurrence based on the steering angle determined in STEP 118C.

STEP 122C, DETERMINE WHETHER THE VEHICLE VELOCITY AND THE CELLULAR TELEPHONE VELOCITY ARE SUBSTANTIALLY PARALLEL AND IN A SAME DIRECTION, includes determining whether the vehicle velocity 18C determined in STEP 108C and the cellular telephone velocity 28C determined in STEP 104C are substantially parallel and in a same direction indicating the autonomous vehicle 10C and the cellular telephone 14C are travelling on the same path in the same direction. As used herein, substantially parallel means within 15 degrees of absolutely parallel. STEP 124C, PROVIDE, BY THE COMPUTER SYSTEM, INSTRUCTIONS TO THE POWERTRAIN SYSTEM TO ADJUST THE VEHICLE VELOCITY TO MAINTAIN A FOLLOWING DISTANCE IF IT IS DETERMINED THAT THE VEHICLE VELOCITY AND THE CELLULAR TELEPHONE VELOCITY ARE SUBSTANTIALLY PARALLEL AND IN THE SAME DIRECTION, includes providing instructions to the powertrain system to adjust the vehicle velocity 18C to maintain a following distance if it is determined that the vehicle velocity 18C and the cellular telephone velocity 28C are substantially parallel and in the same direction. The following distance is based on the vehicle velocity 18C in order to allow a safe stopping distance, if required. STEP 124C may also include determining a velocity threshold for the cellular telephone velocity 28C so that the autonomous vehicle 10C does not automatically match the speed a cellular telephone 14C that is moving too slowly, e.g. a cellular telephone 14C carried by a pedestrian 20C or an other vehicle 24C that is moving too quickly, e.g. a cellular telephone 14C carried by the other vehicle 24C exceeding the posted speed limit.

The embodiments described herein are described in terms of an autonomous vehicle 10C. However, elements of the embodiments may also be applied to warning systems that alert the driver to manually take these identified countermeasures.

Accordingly a method 100C of automatically operating an autonomous vehicle 10C is provided. The method 100C provides the benefits of allowing automatic control of the autonomous vehicle 10C when forward looking sensors are be obscured. It also provides the benefit of receiving location information from cellular telephone 14C that are nearly ubiquitous in the driving environment rather than from dedicated transceivers.

Pulsed LED Vehicle to Vehicle Communication System

For autonomous vehicles traveling in a single file down a stretch of road, it is advantageous for the vehicles to be able to send messages and data up and down the chain of vehicles to ensure that the vehicles are traveling within a safe distance from one another. This is true even for occupant controlled vehicles traveling down a single lane road. For example, if a lead vehicle needs to make a sudden deceleration, the lead vehicle could send information to the rear vehicles to alert the occupants and/or to instruct the rear vehicles to decelerate accordingly or activate the rear vehicles' safety systems, such as automatic braking or seat belt pre-tensioners, if collision is imminent.

It is known to utilizing radio frequency transmissions for relaying vehicle information such as distance between vehicles, speed, acceleration, and vehicle location from a lead vehicle to the rear vehicles. However, the use of radio frequency transmissions require directional transmissions so that radio transmissions from vehicles in the adjacent lanes or opposing traffic do not interfere with the radio transmissions from the lead vehicle to the rear vehicles. Using radio frequency transmissions to communicate may require additional hardware, such as radars, lasers, or other components known in the art to measure the distance, speed, and acceleration between adjacent vehicles. This results in complexity of hardware requirements and data management systems, resulting in a costly vehicle-to-vehicle communication system.

Based on the foregoing and other factors, there remains a need for a low cost, directional, interference resistant communication system for vehicles traveling in single file.

Shown in FIG. 1D is an on road vehicle 10D having an exemplary embodiment of the Light Emitting Diode Vehicle to Vehicle (LED V2V) Communication System 100D of the current invention. The LED V2V Communication System 100D includes LED arrays 102D, 104D for transmitting encoded data; optical receivers 106D, 108D for receiving encoded data; a central-processing-unit 110D, hereafter the CPU 110D, for processing and managing data flow between the LED arrays 102D, 104D and optical receivers 106D, 108D; and a control bus 112D for routing communication between the CPU 110D and the vehicle's systems such as a satellite-based positioning system 114D, driver infotainment system 116D, and safety systems 118D. The safety systems 118D may include audio or visual driver alerts output by the driver infotainment system 116D, active braking 118aD, seat belt pre-tensioners 118bD, air bags 118cD, and the likes.

A front facing LED array 102D configured to transmit an encoded digital signal in the form of light pulses and a front facing optical receiver 106D for receiving a digital signal in the form of light pulses are mounted to the front end of the vehicle. Similarly, mounted to the rear of the vehicle 10D are a rear facing LED array 104D configured to transmit a digital signal in the form of light pulses and a rear optical receiver 108D for receiving a digital signal in the form of light pulses.

Each of the front and rear LED arrays 102D, 104D may include a plurality of individual LEDs that may be activated independently of each other within the LED array. The advantage of this is that the each LED may transmit its own separate and distinct encoded digital signal. The front LED array 102D is positioned where it would be able to transmit unobstructed light pulses to a receiving vehicle immediately in front of the vehicle 10D. Similarly, the rear LED array 104D is positioned where it would be able to transmit unobstructed light pulses to a receiving vehicle immediately behind the vehicle 10D. For aesthetic purposes, the front LED array 102D may be incorporated in the front headlamp assembly of the vehicle 10D and the rear LED array 104D may be incorporated in the brake lamp assembly of the vehicle 10D.

To avoid driver distraction, it is preferable that the LED arrays 102D, 104D emit light pulses outside of the visible light spectrum to the human eye in order to avoid distraction to the drivers of other vehicles. A digital pulse signal is preferred over an analog signal since an analog signal may be subject to degradation as the light pulse is transmitted over harsh environmental conditions. It is preferable that that the LED arrays 102D, 104D emit non-visible light in the infrared frequency to cut through increment weather conditions such as rain, fog, or snow. As an alternative, the LED arrays 102D, 104D may emit light in the ultra-violet frequency range.

The front optical receiver 106D is mounted onto the front of the vehicle 10D such that the front optical receiver 106D has an unobstructed line of sight to a transmitting vehicle immediately in front of the vehicle 10D. Similarly, the rear optical receiver 108D is mounted onto the rear of the vehicle 10D such that the rear optical receiver 108D has an unobstructed line of sight to a transmitting vehicle immediately in rear of the vehicle 10D. As an alternative, the front LED array 102D and front optical receiver 106D may be integrated into a single unit to forming a front LED transceiver, which it is capable of transmitting and receiving a luminous pulse digital signal. Similarly, the rear LED array 104D and rear optical receiver 108D may be integrated as a rear LED transceiver. It should be recognized that each of the exemplary vehicles discussed above in front and rear of vehicle 10D may function as both a receiving and transmitting vehicle, the relevance of which will be discussed below.

A CPU 110D is provided in the vehicle 10D and is configured to receive vehicle input information from a plurality of sources in the vehicle 10D, such as text or voice information from the occupants or data information from the vehicle's GPS 114D, and generates corresponding output information based on the input information. The CPU 110D then sends the output information to the front LED array 102D, the rear LED array 104D, or both, which then transmit the output information as a coded digital signal in the form of light pulses directed to the immediate adjacent front and/or rear vehicles. The CPU HOD is also configured to receive and process incoming messages from the front and rear optical receivers 106D, 108D, and generate an action signal based on the incoming message. A control bus 112D is provided to facilitate electronic communication between the CPU 10D and the vehicle's electronic features such the GPS 114D, driver infotainment system 116D, and safety systems 118D.

Shown in FIG. 2D are three vehicles A, B, C (labeled as Veh. 1, Veh. 2, and Veh. 3, respectively) traveling in a single file formation down a common lane. Each of the three vehicles include an embodiment of the LED V2V Communication System 100D of the currently invention as detailed above. The first vehicle A is traveling ahead and in immediate front of the second vehicle B, which is traveling ahead of and in immediate front of the third vehicle C. While only three vehicles A, B, C are shown, the LED V2V Communication System is not limited to being used by only three vehicles. The LED V2V Communication System 100D is applicable to a plurality of vehicles traveling in a single file where it is desirable to transmit information up and/or down the column of vehicles. For example, the first vehicle A may transmit data to the second vehicle B, and the second vehicle B may re-transmit the data to the third vehicle C, and so on and so forth until the data reaches a designated vehicle or the last vehicle down the chain. Alternatively, data may be transmitted by the last vehicle in the column of vehicles through each vehicle, in series, until the data arrives at the first vehicle A of the chain. For simplicity, the operation of the V2V Communication System will be explained with the three vehicles A, B, C shown and the second vehicle B will be the reference vehicle for illustration and discussion purposes. Each of the vehicles A, B, C may function as a transmitting and a receiving vehicle with respect to an adjacent vehicle in the chain.

Referring to FIG. 3D, communications between vehicles may be initiated autonomously by the V2V Communication System 100D as a part of an overall vehicle safety system. By way of example, the CPU 110D instructs the front LED array 102D to transmit a predetermined digital signal, in the form of luminous pulses, in the direction of the front vehicle A (Veh. 1). The rear reflectors 14D of front vehicle A, which are standard on all vehicles, reflect the pulse of light to the front optical receiver 106D, which then sends a signal back to the CPU 110D. To verify signal integrity, the CPU 110D compares the reflected digital signal with the transmitted digital signal, and if it matches, computes the distance between the central second vehicle B (Veh. 2) and the front first vehicle Abased on the time required for the pulse of light to travel to the front vehicle A and reflected back to the second vehicle B. This operation is continuously repeated and based on the rate in change of distance between the two vehicles A, B, the central-processing-unit determines whether the vehicles A, B are traveling in a safe distance or if collision is likely. As provided above, the CPU 110D processes and manages the transfer of data to and from the LED arrays 102D, 104D and optical receivers 106D, 108D, and the control bus 112D facilitates communication between the CPU 110D and the vehicles electronic features. If the CPU 110D determines that the vehicles are traveling in too close of a distance, the CPU 110D then sends a signal to the driver infotainment system 116D to visually or audibly alert the driver via an in-dash display or vehicle sound system. If the CPU 110D determines that collision is imminent, the CPU 110D could send a signal to the vehicle's braking system 118aD to automatically decelerate the vehicle, or activate seat belt pre-tensioners 118bD and air-bags 118cD, and simultaneously, send transmit a signal to the adjacent rear vehicle C (Veh. 3) using the rear LED array 104D to notify vehicle C that the second vehicle B is slowing. Automated driver early warning of unsafe proximity between adjacent vehicles provides for safer driving, less stress on the driver, and additional reaction time for the drivers.

As an additional safety measure for autonomous and/or driver controlled vehicles, the CPU of the first vehicle may receive vehicle location, direction, and speed information from the first vehicle's GPS system. The first vehicle transmits this information via the first vehicle's rear LED array directly to the second vehicle. The second vehicle's CPU may use algorithms to analyze the GPS data received from the first vehicle together with the second vehicle's own GPS data to determine if the two vehicles are traveling in too close of a distance or if collision is imminent. This determination is compared with the distance information calculated from the time it takes to transmit and received a pulse of light between vehicles to ensure accuracy and reliability of the data received from GPS. Just as the first vehicle passing its GPS information to the second vehicle, the second vehicle passes its GPS information to the third vehicle, and so on and so forth.

Utilizing the V2V Communication System 100D, direct audio or text communications between vehicles may be initiated by an occupant of a vehicle. For example, the occupant of the center vehicle may relay a message to the immediate vehicle in front or rear. As previously mentioned, the V2V Communication system 100D may transmit information down a string of vehicle traveling in a single file down a road. If an upfront vehicle encounters an accident, road obstruction, and/or traffic accident, information can be sent down in series through the string of vehicles to slow down or activate safety systems 118D of individual vehicles to ensure that the column of cars slows evenly to avoid vehicle-to-vehicle collisions. Emergency vehicles may utilize the V2V communication system 100D to warn a column of vehicles. For example, if an emergency vehicle is traveling up from behind, the emergency vehicle having a V2V communication system 100D may communicate the information up the column of vehicles to notify the drivers to pull their vehicles over to the side of the road to allow room for the emergency vehicle to pass.

Method and Apparatus for Controlling an Autonomous Vehicle

Autonomous vehicles typically utilize multiple data sources to determine their location, to identify other vehicles, to identify potential hazards, and to develop navigational routing strategies. These data sources can include a central map database that is preloaded with road locations and traffic rules corresponding to areas on the map. Data sources can also include a variety of sensors on the vehicle itself to provide real-time information relating to road conditions, other vehicles and transient hazards of the type not typically included on a central map database.

In many instances a mismatch can occur between the map information and the real-time information sensed by the vehicle. Various strategies have been proposed for dealing with such a mismatch. For example, U.S. Pat. No. 8,718,861 to Montemerlo et al. teaches detecting deviations between a detailed map and sensor data and alerting the driver to take manual control of the vehicle when the deviations exceed a threshold. U.S. Pub. No. 2014/0297093 to Murai et al. discloses a method of correcting an estimated position of the vehicle by detecting an error in the estimated position, in particular when a perceived mismatch exists between road location information from a map database and from vehicle sensors, and making adjustments to the estimated position.

A variety of data sources can be used for the central map database. For example, the Waze application provides navigational mapping for vehicles. Such navigational maps include transient information about travel conditions and hazards uploaded by individual users. Such maps can also extract location and speed information from computing devices located within the vehicle, such as a smart phone, and assess traffic congestion by comparing the speed of various vehicles to the posted speed limit for a designated section of roadway.

Strategies have also been proposed in which the autonomous vehicle will identify hazardous zones relative to other vehicles, such as blind spots. For example, U.S. Pat. No. 8,874,267 to Dolgov et al. discloses such a system. Strategies have also been developed for dealing with areas that are not detectable by the sensors on the vehicle. For example, the area behind a large truck will be mostly invisible to the sensors on an autonomous vehicle. U.S. Pat. No. 8,589,014 to Fairfield et al. teaches a method of calculating the size and shape of an area of sensor diminution caused by an obstruction and developing a new sensor field to adapt to the diminution.

Navigational strategies for autonomous vehicles typically include both a destination-based strategy and a position-based strategy. Destination strategies involve how to get from point ‘A’ to point ‘B’ on a map using known road location and travel rules. These involve determining a turn-by-turn path to direct the vehicle to the intended destination. Position strategies involve determining optimal locations for the vehicle (or alternatively, locations to avoid) relative to the road surface and to other vehicles. Changes to these strategies are generally made during the operation of the autonomous vehicle in response to changing circumstances, such as changes in the position of surrounding vehicles or changing traffic conditions that trigger a macro-level rerouting evaluation by the autonomous vehicle.

Position-based strategies have been developed that automatically detect key behaviors of surrounding vehicles. For example, U.S. Pat. No. 8,935,034 to Zhu et al. discloses a method for detecting when a surrounding vehicle has performed one of several pre-defined actions and altering the vehicle control strategy based on that action.

One of many challenges for controlling autonomous vehicles is managing interactions between autonomous vehicles and human-controlled vehicles in situations that are often handled by customs that are not easily translated into specific driving rules.

FIG. 1E is a functional block diagram of a vehicle 100E in accordance with an example embodiment. Vehicle 100E has an external sensor system 110E that includes cameras 112E, radar 114E, and microphone 116E. Vehicle 100E also includes an internal sensor system 120E that includes speed sensor 122E, compass 124E and operational sensors 126E for measuring parameters such as engine temperature, tire pressure, oil pressure, battery charge, fuel level, and other operating conditions. Control systems 140E are provided to regulate the operation of vehicle 100E regarding speed, braking, turning, lights, wipers, horn, and other functions. A geographic positioning system 150E is provided that enables vehicle 100E to determine its geographic location. Vehicle 100E communicates with a navigational database 160E maintained in a computer system outside the vehicle 100E to obtain information about road locations, road conditions, speed limits, road hazards, and traffic conditions. Computer 170E within vehicle 100E receives data from geographic positioning system 150E and navigational database 160E to determine a turn-based routing strategy for driving the vehicle 100E from its current location to a selected destination. Computer 170E receives data from external sensor system 110E and calculates the movements of the vehicle 100E needed to safely execute each step of the routing strategy. Vehicle 100E can operate in a fully autonomous mode by giving instructions to control systems 140E or can operate in a semi-autonomous mode in which instructions are given to control systems 140E only in emergency situations. Vehicle 100E can also operate in an advisory mode in which vehicle 100E is under full control of a driver but provides recommendations and/or warnings to the driver relating to routing paths, potential hazards, and other items of interest.

FIG. 2E illustrates vehicle 100E driving along highway 200E including left lane 202E, center lane 204E, and right lane 206E. Other-vehicles 220E, 230E, and 240E are also travelling along highway 200E in the same direction of travel as vehicle 100E. Computer 170E uses data from external sensor system 110E to detect the other-vehicles 220E, 230E, and 240E, to determine their relative positions to vehicle 100E and to identify their blind spots 222E, 232E and 242E. Other-vehicle 220E and the vehicle 100E are both in the left lane 202E and other-vehicle 220E is in front of vehicle 100E. Computer 170E uses speed information from internal sensor system 120E to calculate a safe following distance 260E from other-vehicle 220E. In the example of FIG. 2E, the routing strategy calculated by computer 170E requires vehicle 100E to exit the highway 200E at ramp 270E. In preparation for exiting the highway 200E, computer 170E calculates a travel path 280E for vehicle 100E to move from the left lane 202E to the right lane 206E while avoiding the other-vehicles 220E, 230E, and 240E and their respective blind spots 222E, 232E and 242E.

FIG. 3aE illustrates map 300E received by computer 170E from navigational database 160E. Map 300E includes the location and orientation of road network 310E. In the example shown, vehicle 100E is travelling along route 320E calculated by computer 170E or, alternatively, calculated by a computer (not shown) external to vehicle 100E associated with the navigational database 160E. FIG. 3bE illustrates an enlarged view of one portion of road network 310E and route 320E. Fundamental navigational priorities such as direction of travel, target speed and lane selection are made with respect to data received from navigational database 160E. Current global positioning system (GPS) data has a margin of error that does not allow for absolute accuracy of vehicle position and road location. Therefore, referring back to FIG. 2E, computer 170E uses data from external sensor system 110E to detect instance of road features 330E such as lane lines 332E, navigational markers 334E, and pavement edges 336E to control the fine positioning of vehicle 100E. Computer 170E calculates the GPS coordinates of detected instances of road features 330E, identifies corresponding map elements 340E, and compares the location of road features 330E and map elements 340E. FIG. 3bE is an enlarged view of a portion of map 300E from FIG. 3aE that shows a map region 350E in which there is a significant discrepancy between road features 330E and map elements 340E as might occur during a temporary detour. As discussed below, significant differences between the calculated position of road features 330E and map elements 340E will cause computer 170E to adjust a routing strategy for vehicle 100E.

In an alternative embodiment, road features 330E and map elements 340E can relate to characteristics about the road surface such as the surface material (dirt, gravel, concrete, asphalt). In another alternative embodiment, road features 330E and map elements 340E can relate to transient conditions that apply to an area of the road such as traffic congestion or weather conditions (rain, snow, high winds).

FIG. 4E illustrates an example flow chart 400E in accordance with some aspects of the disclosure discussed above. In block 402E, computer 170E adopts a default control strategy for vehicle 100E. The default control strategy includes a set of rules that will apply when there is a high degree of correlation between road features 330E and map elements 340E. For example, under the default control strategy the computer 170E follows a routing path calculated based on the GPS location of vehicle 100E with respect to road network 310E on map 300E. Vehicle 100E does not cross lane lines 332E or pavement edges 336E except during a lane change operation. Vehicle target speed is set based on speed limit information for road network 310E contained in navigational database 160E, except where user preferences have determined that the vehicle should travel a set interval above or below the speed limit. The minimum spacing between vehicle 100E to surrounding vehicles is set to a standard interval. External sensor system 110E operates in a standard mode in which the sensors scan in a standard pattern and at a standard refresh rate.

In block 404E, computer 170E selects a preferred road feature 330E (such as lane lines 332E) and determines its respective location. In block 406E, computer 170E determines the location of the selected instance of the road feature 330E and in block 408E compares this with the location of a corresponding map element 340E. In block 410E, computer 170E determines a correlation rate between the location of road feature 330E and corresponding map element 340E. In block 412E, computer 170E determines whether the correlation rate exceeds a predetermined value. If not, computer 170E adopts an alternative control strategy according to block 414E and reverts to block 404E to repeat the process described above. If the correlation rate is above the predetermined value, computer maintains the default control strategy according to block 416E and reverts to block 404E to repeat the process.

The correlation rate can be determined based on a wide variety of factors. For example, in reference to FIG. 3bE computer 170E can calculate the distance between road feature 330E and map element 340E at data points 370E, 372E, 374E, 376E, and 378E along map 300E. If the distance at each point exceeds a defined value, computer 170E will determine that the correlation rate is below the predetermined value. If this condition is reproduced over successive data points or over a significant number of data points along a defined interval, computer 170E will adopt the alternative control strategy. There may also be locations in which road features 330E are not detectable by the external sensor system 110E. For example, lane lines 332E may be faded or covered with snow. Pavement edges 334E may be also covered with snow or disguised by adjacent debris. Data points at which no correlation can be found between road features 330E and map elements 340E could also be treated as falling below the correlation rate even though a specific calculation cannot be made.

In one embodiment of the disclosure, only one of the road features 330E, such as lane lines 332E, are used to determine the correlation between road features 330E and map elements 340E. In other embodiments of the disclosure, the correlation rate is determined based on multiple instances of the road features 330E such as lane lines 332E and pavement edges 336E. In yet another embodiment of the disclosure, the individual correlation between one type of road feature 330E and map element 340E, such as lane lines 332E, is weighted differently than the correlation between other road features 330E and map elements 340E, such as pavement edges 334E, when determining an overall correlation rate. This would apply in situations where the favored road feature (in this case, lane lines 332E) is deemed a more reliable tool for verification of the location of vehicle 100E relative to road network 310E.

FIG. 5E illustrates an example flow chart 500E for the alternative control strategy, which includes multiple protocols depending upon the situation determined by computer 170E. In block 502E, computer 170E has adopted the alternative control strategy after following the process outlined in FIG. 4E. In block 504E, computer 170E selects an alternative road feature 330E (such as pavement edges 336E) and determines its respective location in block 506E. In block 508E, computer 170E compares the location of the selected road feature 330E to a corresponding map element 340E and determines a correlation rate in block 510E. In block 512E, computer 170E determines whether the correlation rate falls above a predetermined value. If so, computer 170E adopts a first protocol for alternative control strategy according to block 514E. If not, computer 170E adopts a second protocol for the alternative control strategy according to block 516E.

In the first protocol, computer 170E relies on a secondary road feature 330E (such as pavement edges 336E) for verification of the location of road network 310E relative to the vehicle 100E and for verification of the position of vehicle 100E within a lane on a roadway (such as the left lane 202E in highway 200E, as shown in FIG. 2E). In a further embodiment, computer 170E in the first protocol may continue to determine a correlation rate for the preferred road feature 330E selected according to the process outlined in FIG. 4E and, if the correlation rate exceeds a predetermined value, return to the default control strategy.

The second protocol is triggered when the computer is unable to reliably use information about alternative road features 330E to verify the position of the vehicle 100E. In this situation, computer 170E may use the position and trajectory of surrounding vehicles to verify the location of road network 310E and to establish the position of vehicle 100E. If adjacent vehicles have a trajectory consistent with road network 310E on map 300E, computer will operate on the assumption that other vehicles are within designated lanes in a roadway. If traffic density is not sufficiently dense (or is non-existent) such that computer 170E cannot reliably use it for lane verification, computer 170E will rely solely on GPS location relative to the road network 310E for navigational control purposes.

In either control strategy discussed above, computer 170E will rely on typical hazard avoidance protocols to deal with unexpected lane closures, accidents, road hazards, etc. Computer 170E will also take directional cues from surrounding vehicles in situations where the detected road surface does not correlate with road network 310E but surrounding vehicles are following the detected road surface, or in situations where the path along road network 310E is blocked by a detected hazard but surrounding traffic is following a path off of the road network and off of the detected road surface.

In accordance with another aspect of the disclosure, referring back to FIG. 2E computer 170E uses data from external sensor system 110E to detect road hazard 650E on highway 600E and to detect shoulder areas 660E and 662E along highway 200E. Computer 170E also uses data from external sensor system 110E to detect hazard 670E in the shoulder area 660E along with structures 680E such as guard rails or bridge supports that interrupt shoulder areas 660E, 662E.

Computer 170E communicates with navigational database 160E regarding the location of hazards 650E, 670E detected by external sensor system 110E. Navigational database 160E is simultaneously accessible by computer 170E and other computers in other vehicles and is updated with hazard-location information received by such computers to provide a real-time map of transient hazards. In a further embodiment, navigational database 160E sends a request to computer 170E to validate the location of hazards 650E, 670E detected by another vehicle. Computer 170E uses external sensor system 110E to detect the presence or absence of hazards 650E, 670E and sends a corresponding message to navigational database 160E.

In accordance with another aspect of the disclosure, FIG. 6aE illustrates vehicle 100E driving along highway 600E including left lane 602E, center lane 604E, and right lane 606E. Surrounding vehicles 620E are also travelling along highway 600E in the same direction of travel as vehicle 100E. Computer 170E receives data from geographic positioning system 150E and navigational database 160E to determine a routing strategy for driving the vehicle 100E from its current location to a selected destination 610E. Computer 170E determines a lane-selection strategy based on the number of lanes 602E, 604E, 606E on highway 600E, the distance to destination 610E, and the speed of vehicle 100E. The lane-selection strategy gives a preference for the left lane 602E when vehicle 100E remains a significant distance from destination 610E. The lane-selection strategy also disfavors the right lane in areas along highway 600E with significant entrance ramps 622E and exit ramps 624E. The lane selection strategy defines first zone 630E where vehicle 100E should begin to attempt a first lane change maneuver into center lane 604E, and a second zone 632E where vehicle should begin to attempt a second lane change maneuver into right lane 606E. When vehicle 100E reaches first or second zone 630E, 632E, computer 170E directs vehicle 100E to make a lane change maneuver as soon as a safe path is available, which could include decreasing or increasing the speed of vehicle 100E to put it in a position where a safe path is available. If vehicle passes through a zone 630E, 632E without being able to successfully make a lane change maneuver, vehicle 100E will continue to attempt a lane change maneuver until it is no longer possible to reach destination 610E at which point the computer 170E will calculate a revised routing strategy for vehicle 100E.

Computer 170E adapts the lane selection strategy in real time based on information about surrounding vehicles 620E. Computer 170E calculates a traffic density measurement based on the number and spacing of surrounding vehicles 620E in the vicinity of vehicle 100E. Computer 170E also evaluates the number and complexity of potential lane change pathways in the vicinity of vehicle 100E to determine a freedom of movement factor for vehicle 100E. Depending upon the traffic density measurement, the freedom of movement factor, or both, computer 170E evaluates whether to accelerate the lane change maneuver. For example, when traffic density is heavy and freedom of movement limited for vehicle 100E, as shown in FIG. 7bE, computer 170E may locate first and second zones 734E and 736E farther from destination 710E to give vehicle 100E more time to identify a safe path to maneuver. This is particularly useful when surrounding vehicles 620E are following each other at a distance that does not allow for a safe lane change between them.

In another aspect of the disclosure as shown in FIG. 2E, computer 170E uses data from external sensor system 110E to detect the other-vehicles 220E, 230E, and 240E and to categorize them based on size and width into categories such as “car”, “passenger truck” and “semi-trailer truck.” In FIG. 2E, other-vehicles 220E and 230E are passenger cars and other-vehicle 240E is a semi-trailer truck, i.e. a large vehicle. In addition to identifying the blind spots 222E, 232E and 242E, computer 170E also identifies hazard zones 250E that apply only to particular vehicle categories and only in particular circumstances. For example, in FIG. 2E computer 170E has identified the hazard zones 250E for other-vehicle 240E that represent areas where significant rain, standing water, and/or snow will be thrown from the tires of a typical semi-trailer truck. Based on information about weather and road conditions from navigational database 160E, road conditions detected by external sensor system 110E, or other sources, computer 170E determines whether the hazard zones 250E are active and should be avoided.

FIG. 7E illustrates a top view of vehicle 100E including radar sensors 710E and cameras 720E. Because a vehicle that is driven under autonomous control will likely have behavior patterns different from a driver-controlled vehicle, it is important to have a signal visible to other drivers that indicates when vehicle 100E is under autonomous control. This is especially valuable for nighttime driving when it may not be apparent that no one is in the driver's seat, or for situations in which a person is in the driver's seat but the vehicle 100E is under autonomous control. For that purpose, warning light 730E is provided and is placed in a location distinct from headlamps 740E, turn signals 750E, or brake lights 760E. Preferably, warning light 730E is of a color other than red, yellow, or white to further distinguish it from normal operating lights/signals 740E, 750E, and 760E. In one embodiment, warning light can comprise an embedded light emitting diode (LED) located within a laminated glass windshield 770E and/or laminated glass backlight 780E of vehicle 100E.

One of the complexities of autonomous control of vehicle 100E arises in negotiating the right-of-way between vehicles. Driver-controlled vehicles often perceive ambiguity when following the rules for determining which vehicle has the right of way. For example, at a four-way stop two vehicles may each perceive that they arrived at an intersection first. Or one vehicle may believe that all vehicles arrived at the same time but another vehicle perceived that one of the vehicles was actually the first to arrive. These situations are often resolved by drivers giving a visual signal that they are yielding the right of way to another driver, such as with a hand wave. To handle this situation when vehicle 100E is under autonomous control, yield signal 790E is included on vehicle 100E. Computer 170E follows a defined rule set for determining when to yield a right-of-way and activates yield signal 790E when it is waiting for the other vehicle(s) to proceed. Yield signal 790E can be a visual signal such as a light, an electronic signal (such as a radio-frequency signal) that can be detected by other vehicles, or a combination of both.

In accordance with another aspect of the disclosure, FIG. 8E illustrates vehicle 100E driving along road 800E. Road 810E crosses road 800E at intersection 820E. Buildings 830E are located along the sides of road 810E and 820E. Computer 170E uses data from external sensor system 110E to detect approaching-vehicle 840E. However, external sensor system 110E cannot detect hidden-vehicle 850E travelling along road 810E due to interference from one or more buildings 830E. Remote-sensor 860E is mounted on a fixed structure 870E (such as a traffic signal 872E) near intersection 820E and in a position that gives an unobstructed view along roads 800E and 810E. Computer 170E uses data from remote-sensor 860E to determine the position and trajectory of hidden-vehicle 850E. This information is used as needed by computer 170E to control the vehicle 100E and avoid a collision with hidden-vehicle 850E. For example, if vehicle 100E is approaching intersection 820E with a green light on traffic signal 872E, computer 170E will direct the vehicle 100E to proceed through intersection 820E. However, if hidden-vehicle 850E is approaching intersection 820E at a speed or trajectory inconsistent with a slowing or stopping behavior, computer 170E will direct vehicle to stop short of intersection 820E until it is determined that hidden-vehicle 850E will successfully stop at intersection 820E or has passed through intersection 820E.

Autonomous Vehicle with Unobtrusive Sensors

An autonomously driven vehicle requires that the surroundings of the vehicle be sensed more or less continually and, more importantly, for 360 degrees around the perimeter of the car.

Atypical means for sensing is a relatively large LIDAR unit (a sensor unit using pulsed laser light rather than radio waves). An example of a known-vehicle 12F is shown in FIG. 1, showing a large LIDAR unit 10F extending prominently above the roof line of the known-vehicle 12F. The size and elevation and 360 degree shape of the unit 10F make it feasible to generate the data needed, but it is clearly undesirable from the standpoint of aesthetics, aerodynamics, and cost.

Referring now to the FIGS. 1F-4F, the invention will be described with reference to specific embodiments, without limiting same. Where practical, reference numbers for like components are commonly used among multiple figures.

Referring first to FIGS. 2F and 3F, a conventional vehicle 14F, hereafter referred to as the vehicle 14F, has a pre-determined exterior surface comprised generally of body sections including roof 16F, front bumper section 18F, rear bumper section 20F, front windshield 22F, rear window 24F, vehicle-sides 26F. Such are rather arbitrary distinctions and delineations in what is basically a continuous outer surface or skin comprised thereof. However, a typical car owner or customer will recognize that there is a basic, conventional outer surface, desirably free of severe obtrusions therebeyond, both for aesthetic and aerodynamic reasons. In addition, an antenna housing 28F on the roof, commonly referred to as a “shark fin,” has become commonplace and accepted, and can be considered part of a conventional outer surface, thought it might have been considered an obtrusion at one point in time.

Referring next to FIG. 4F, a car that can potentially be autonomously driven will need sensing of the environment continually, and, just as important, 360 degrees continuously around. That is easily achieved by a large, top mounted LIDAR unit, but that is undesirable for the reasons noted above. In the preferred embodiment disclosed here, several technologies owned by the assignee of the present invention enable the need to be met in an aesthetically non objectionable fashion, with no use of a LIDAR unit. Mounted behind and above the front windshield 22F is a camera-radar fusion unit 30F of the typed disclosed in co-assigned U.S. Pat. No. 8,604,968, incorporated herein by reference. Camera-radar fusion unit 30F has unique and patented features that allow it to be mounted directly and entirely behind front windshield 22F, and so “see” and work through, the glass of front windshield 22F, with no alteration to the glass. The camera-radar fusion unit 30F is capable of providing and “fusing” the data from both a camera and a radar unit, providing obstacle recognition, distance and motion data, and to cover a large portion of the 360 degree perimeter. More detail on the advantages can be found in the US patent noted, but, for purposes here, the main advantage is the lack of interference with or alteration of the exterior or glass of the vehicle 14F.

Still referring to FIG. 4, several instances of radar units 32F may be mounted around the rest of the perimeter of vehicle 14F, shown in the preferred embodiment as two in front bumper section 18F, two in rear bumper section 20F, four evenly spaced around the vehicle-sides 26F. The number disclosed is exemplary only, and would be chosen so as to sweep out the entire 360 degree perimeter without significant overlap. Radar units 32F disclosed in several co pending and co assigned patent applications provide compact and effective units that can be easily unobtrusively mounted, without protrusion beyond the exterior vehicle surface, such as behind bumper fascia, in side mirrors, etc. By way of example, U.S. Ser. No. 14/187,404, filed Mar. 5, 2014, discloses a compact unit with a unique antennae array that improves detection range and adds elevation measurement capability. U.S. Ser. No. 14/445,569, filed Jul. 29, 2014, discloses a method for range-Doppler compression. In addition, U.S. Ser. No. 14/589,373, filed Jan. 5, 2015, discloses a 360 degree radar capable of being enclosed entirely within the antenna housing 28F, which would give a great simplification. Fundamentally, the sensors would be sufficient in number to give essentially a complete, 360 degree perimeter of coverage.

While the invention has been described in detail in connection with only a limited number of embodiments, it should be readily understood that the invention is not limited to such disclosed embodiments. Within the broad objective of providing 360 degree sensor coverage, while remaining within the exterior envelope of the car, other compact or improved sensors could be used.

Adaptive Cruise Control Integrated with Lane Keeping Assist System

Earlier cruise control systems, decades old now, allowed a driver to set a certain speed, typically used on highways in fairly low traffic situations, where not a lot of stop and go traffic could be expected. This was necessary, as the systems could not account for closing of the distance behind a leading-vehicle. It was incumbent upon the driver to notice this, and step on the brake, which would also cancel the cruise control setting, necessitating that it be reset. This was an obvious annoyance in stop and go traffic, so the system would unlikely be used in that situation. The systems typically did not cancel the setting for mere acceleration, allowing for the passing of slower leading-vehicles, and a return to the set speed when the passing car returned to its lane.

Newer cruise control systems, typically referred to as adaptive cruise control, use a combination of radar and camera sensing to actively hold a predetermined distance threshold behind the leading car. These vary in how actively they decelerate the car, if needed, to maintain the threshold. Some merely back off of the throttle, some provide a warning to the driver and pre-charge the brakes, and some actively brake while providing a warning.

Appearing on vehicles more recently have been so called lane keeping systems, to keep or help to keep a vehicle in the correct lane. These also vary in how active they are. Some systems merely provide audible or haptic warnings if it is sensed that the car is drifting out of its lane, or if an approaching car is sensed as a car attempts to pass a leading car. Others will actively return the car to the lane if an approaching car is sensed.

Referring first to FIGS. 1G and 3G, a trailing-vehicle 10G equipped with an active cruise control system, hereafter the system 28G, suitable for automated operation of the trailing-vehicle 10G is shown behind a leading-vehicle 12G at the predetermined or normal following threshold-distance T. A method 30G of operating the system 28G is illustrated in FIG. 3G. At the logic box 14G, the system 28G determines if the trailing-vehicle 10G is at and has maintained the threshold T. If not, as due to the leading-vehicle 12G slowing down, the decision box 16G illustrates that the active cruise control system will also slow down trailing-vehicle 10G, by de-throttling, braking, or some combination of the two until the threshold following-distance is re attained.

Referring next to FIGS. 2G and 3G, the trailing-vehicle 10G is shown after trying and failing to pass the leading-vehicle 12G, so the trailing-vehicle 10G is shifting fairly suddenly back to the original lane, while the system 28G is still engaged. As noted, this is an expected scenario as the trailing-vehicle 10G would normally not use the brake, but only accelerate, in order to change lanes and attempt to pass the leading-vehicle. This scenario would not disengage the system. If, due either to driver action or the effect of an active lane keeping system (i.e. the system 28G), the trailing-vehicle 10G shifts abruptly back to the original lane, it could end up closer to the leading-vehicle 12G at a following-distance X less than a minimum-distance which is less than less than the threshold-distance T. In that event, the driver might not notice immediately, nor apply the brake quickly. In that case, as shown by the decision box 18G, the cruise control system would switch to a more aggressive than normal deceleration scheme until the threshold T is again attained. In the event that the driver did apply the brake at some point still within the less than threshold-distance T, the system 28G could be configure not to disengage the active cruise control until the threshold-distance T was achieved.

The temporarily more aggressive deceleration would be beneficial regardless of whether the abrupt return to the original lane was due to driver direct action or the action of an active lane keeping system. However, it is particularly beneficial when the two are integrated, as a driver inattentive to an approaching vehicle in the adjacent lane is likely to be equally inattentive to the proximity of a leading-vehicle in the original lane.

While this invention has been described in terms of the preferred embodiments thereof, it is not intended to be so limited, but rather only to the extent set forth in the claims that follow.

What is claimed is:

1. A method comprising:
receiving, via an electronic receiver of a vehicle, a message from another vehicle; and
responsive to receiving the message from the other vehicle, providing, by a computer system of the vehicle in communication with said electronic receiver and to a vehicle system of the vehicle, instructions that configure the vehicle system of the vehicle to automatically implement countermeasure behavior with the vehicle.

2. The method of claim 1, wherein:
the message includes data indicative of a location of the other vehicle;
the vehicle system includes a braking system; and
providing the instructions includes providing at least a portion of the instructions to the braking system that configure the braking system to apply brakes of the vehicle based on a speed of the vehicle and a distance between the vehicle and the location of the other vehicle.

3. The method of claim 2, wherein:
the message further includes data indicative of whether the other vehicle is stopped; and
providing the instructions further includes providing at least another portion of the instructions to the braking system that configure the braking system to apply brakes of the vehicle based further on the data indicative of whether the other vehicle is stopped.

4. The method of claim 3, wherein the other vehicle includes a school bus and the data indicative of whether the other vehicle is stopped is a stop signal status of the school bus.

5. The method of claim 2, wherein:
the message further includes data indicative of a safe following distance to the other vehicle; and
providing the instructions further includes providing at least another portion of the instructions to the braking system that configure the braking system to apply brakes of the vehicle based further on the safe following distance to the other vehicle.

6. The method of claim 5, wherein:
providing the instructions further includes providing the at least other portion of the instructions to the braking system to apply vehicle brakes of the vehicle in response to determining that a difference between the safe following distance of the other vehicle and the distance between the vehicle and the location of the other vehicle and is less than a threshold.

7. The method of claim 6, further comprising:
providing, by the computer system and to a powertrain system of the vehicle, additional instructions to adjust the speed of the vehicle so that the difference between the safe following distance of the other vehicle and the distance between the vehicle and the location of the other vehicle and is less than or equal to zero.

8. The method of claim 2, wherein:
the message further includes data indicative of an emergency warning light status of the other vehicle; and
providing the instructions further includes providing at least another portion of the instructions to the braking system that configure the braking system to apply brakes of the vehicle based further on the emergency warning light status of the other vehicle.

9. The method of claim 8, further comprising:
determining, via a forward looking sensor of the vehicle, a location of an unobstructed portion of a road shoulder, wherein
providing the instructions further includes providing the at least other portion of the instructions to the braking system that configure the braking system to apply brakes of the vehicle based further on the location of the unobstructed portion of the road shoulder.

10. The method of claim 9, further comprising:
determining a steering angle based on the distance between the vehicle and the other vehicle and the location of the unobstructed portion of the road shoulder, wherein
providing the instructions further includes providing additional instructions to at least one of a steering system of the vehicle or a power train system of the vehicle that adjust a travel path of the vehicle based on the steering angle.

11. A autonomous system of a vehicle comprising:
an electronic receiver configured to receive a message from another vehicle; and
a computer system configured to in response to receiving the message from the other vehicle, provide instructions to a vehicle system that configures the vehicle system to automatically implement countermeasure behavior with the vehicle.

12. The autonomous system of claim 11, wherein:
the message includes data indicative of a location of the other vehicle;
the vehicle system includes a braking system; and
the computer system is configured to provide the instructions by providing instructions to the braking system that configure the braking system to apply brakes of the vehicle based on a speed of the vehicle and a distance between the vehicle and the location of the other vehicle.

13. The autonomous system of claim 12, wherein:
the message further includes data indicative of whether the other vehicle is stopped; and
the computer system is configured to provide the instructions by providing instructions to the braking system that configure the braking system to apply brakes of the vehicle based further on the data indicative of whether the other vehicle is stopped.

14. The autonomous system of claim 13, wherein the other vehicle includes a school bus and the data indicative of whether the other vehicle is stopped is a stop signal status of the school bus.

15. The autonomous system of claim 12, wherein:
the message further includes data indicative of a safe following distance to the other vehicle; and
the computer system is configured to provide the instructions by providing instructions to the braking system that configure the braking system to apply brakes of the vehicle based further on the safe following distance to the other vehicle.

16. The autonomous system of claim 15, wherein the computer system is configured to provide the instructions by providing instructions to the braking system to apply vehicle brakes of the vehicle in response to determining that a difference between the safe following distance of the other vehicle and the distance between the vehicle and the location of the other vehicle and is less than a threshold.

17. The autonomous system of claim 16, wherein the computer system is further configured to provide, to a powertrain system of the vehicle, additional instructions to adjust the speed of the vehicle so that the difference between the safe following distance of the other vehicle and the distance between the vehicle and the location of the other vehicle and is less than or equal to zero.

18. The autonomous system of claim 12, wherein:
the message further includes data indicative of an emergency warning light status of the other vehicle; and
the computer system is configured to provide the instructions by providing instructions to the braking system that configure the braking system to apply brakes of the vehicle based further on the emergency warning light status of the other vehicle.

19. The autonomous system of claim 18, further comprising:
determining, via a forward looking sensor of the vehicle, a location of an unobstructed portion of a road shoulder; and
determining a steering angle based on the distance between the vehicle and the other vehicle and the location of the unobstructed portion of the road shoulder,
wherein providing the instructions further includes:
providing instructions to the braking system that configure the braking system to apply brakes of the vehicle based further on the location of the unobstructed portion of the road shoulder; and
providing additional instructions to at least one of a steering system of the vehicle or a power train system of the vehicle that adjust a travel path of the vehicle based on the steering angle.

20. A system comprising:
means for receiving a message by a vehicle and from another vehicle; and
means for providing instructions to a braking system of the vehicle or a power train system of the vehicle that configure the braking system or the power train system to automatically adjust a speed of the vehicle as a countermeasure behavior in response to receiving the message by the vehicle from the other vehicle.
